(19) United States
(12) Patent Application Publication
(10) Pub. No.: US 2026/0184325 A1
(43) Pub. Date: Jul. 2, 2026

(54) CONTROL METHOD FOR INFORMATION PROCESSING DEVICE AND INFORMATION PROCESSING DEVICE

(71) Applicant: NISSAN MOTOR CO., LTD., Kanagawa (JP)

(72) Inventors: Satomi Eto, Kanagawa (JP); Shinji Matsuzaki, Kanagawa (JP)

(73) Assignee: NISSAN MOTOR CO., LTD., Kanagawa (JP)

(21) Appl. No.: 18/863,894

(22) PCT Filed: Mar. 7, 2023
(86) PCT No.: PCT/JP2023/008629

§ 371 Date: Nov. 7, 2024

(30) Foreign Application Priority Data
May 11, 2022 (JP) 2022-078424

(51) Int. Cl. B60W 50/14; B60K 35/28; B60W 50/02; G06T 13/40

(52) U.S. Cl. CPC B60W 50/14; B60K 35/28; B60W 50/0205; G06T 13/40; B60K 2360/162; B60K 2360/1876; B60W 2050/146

(57) ABSTRACT

A control method is for an information processing device that changes a mode of a character. The control method includes determination processing of determining whether maintenance of a vehicle is executed and control processing of changing, based on execution of the maintenance, at least one of an appearance or an operation of the character so as to be a mode related to the executed maintenance and a different mode according to a maintenance content.

### TECHNICAL FIELD

The present invention relates to a control method for an information processing device that changes a mode of a character and an information processing device.

### BACKGROUND ART

In the related art, there is a technique of notifying a maintenance period of a vehicle. JP1998-38605A discloses that an accumulated value including an accumulated travel distance or an accumulated engine driving time is compared with a set value, and when the accumulated value is equal to or greater than the set value, arrival of a maintenance period is notified.

### SUMMARY OF INVENTION

In the related art described above, a user may execute a maintenance work of a vehicle according to notification at a timing when the arrival of the maintenance period is notified. However, even when the maintenance work of the vehicle is executed at the timing of the notification, the user only feels that the maintenance work is executed based on an instruction. In this case, it is difficult to enhance awareness of the user to actively manage the vehicle without feeling attachment to the vehicle.

An object of the present invention is to enhance attachment to a vehicle and to enhance initiative to actively manage the vehicle.

An aspect of the present invention is a control method for an information processing device that changes a mode of a character. The control method includes determination processing of determining whether vehicle maintenance is executed; and control processing of changing at least one of an appearance or an operation of the character based on execution of the maintenance.

### BRIEF DESCRIPTION OF DRAWINGS

FIG. 1 is a perspective view illustrating an example of an appearance configuration of a vehicle.

FIG. 2 is a simplified view illustrating a configuration example of an interior of a cabin of the vehicle when viewed from a rear side in a front-rear direction of the vehicle.

FIG. 3 is a block diagram illustrating an example of a functional configuration of an information processing system.

FIG. 4 is a diagram schematically illustrating information stored in an evaluation value DB.

FIG. 5 is a diagram schematically illustrating information stored in maintenance information DB.

FIG. 6 is a diagram illustrating a relation between a contamination degree of a body of the vehicle and a character displayed on a display unit of an information output device.

FIG. 7 is a diagram illustrating a relation between a deterioration degree of a cooling system of the vehicle and the character displayed on the display unit of the information output device.

FIG. 8 is a diagram illustrating a relation between a deterioration degree of a wiper of the vehicle and the character displayed on the display unit of the information output device.

FIG. 9 is a flowchart illustrating an example of deteriorated component determination processing in the information processing device.

FIG. 10 is a flowchart illustrating an example of contamination determination processing of the vehicle in the information processing device.

FIG. 11 is a flowchart illustrating an example of cooling system deterioration determination processing in the information processing device.

FIG. 12 is a flowchart illustrating an example of wiper deterioration determination processing in the information processing device.

FIG. 13 is a flowchart illustrating an example of tire groove determination processing in the information processing device.

FIG. 14 is a flowchart illustrating an example of tire air pressure determination processing in the information processing device.

FIG. 15 is a flowchart illustrating an example of maintenance execution determination processing in the information processing device.

FIG. 16 is a flowchart illustrating an example of character output processing in the information processing device.

FIG. 17 is a block diagram illustrating an example of a system configuration of the information processing system.

FIG. 18 is a diagram illustrating a simplified configuration example of the interior of the cabin of the vehicle.

### DESCRIPTION OF EMBODIMENTS

Hereinafter, an embodiment of the present invention will be described with reference to the accompanying drawings.

### Appearance Configuration Example of Vehicle

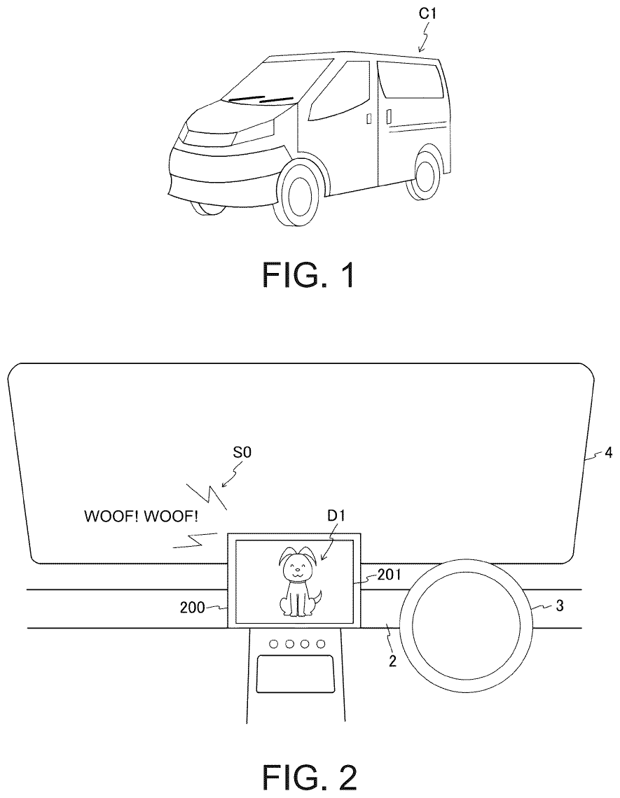

FIG. 1 is a perspective view illustrating an example of an appearance configuration of a vehicle C1. The vehicle C1 is a vehicle such as an internal combustion engine vehicle, a hybrid vehicle, or an electric vehicle.

### Internal Configuration Example of Vehicle

FIG. 2 is a diagram illustrating a simplified configuration example of an interior of a cabin of the vehicle C1 when viewed from a rear side in a front-rear direction of the vehicle C1. In FIG. 2, illustration other than a dashboard 2, a steering wheel 3, a windshield 4, and an information output device 200 is omitted for ease of description.

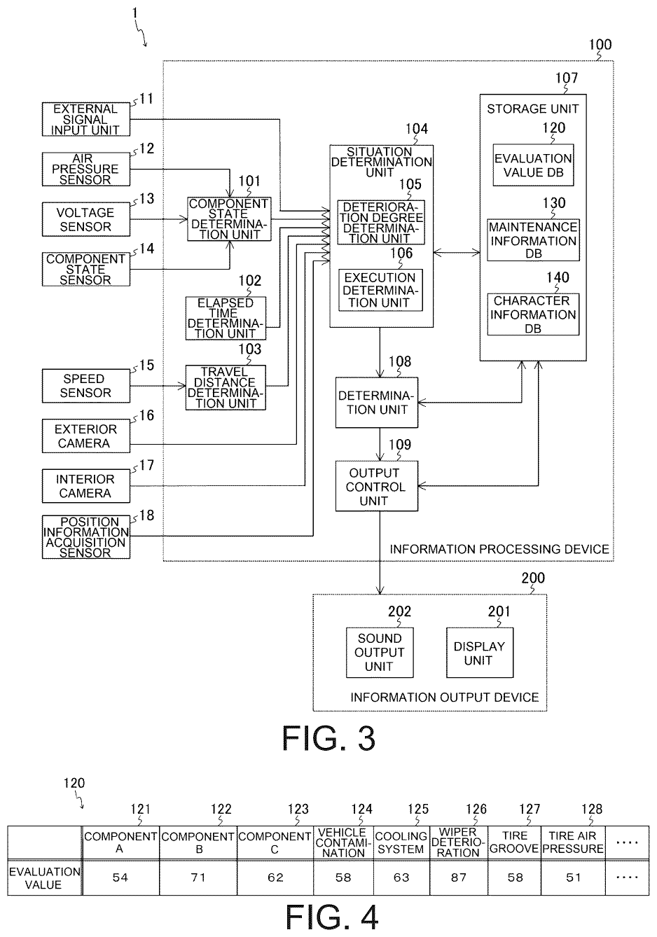

The information output device 200 is a device that outputs various types of information based on control of an information processing device 100 (see FIG. 3). The information output device 200 may be, for example, a touch panel capable of receiving a user operation in response to a touch operation by a user. The information output device 200 is implemented by, for example, a tablet terminal, a car navigation device, or an in-vehicle infotainment (IVI). Although FIG. 2 illustrates an example in which the information output device 200 is installed on the dashboard 2, a position at which the information output device 200 is installed is not limited thereto. For example, the information output device 200 may be installed above a rear seat as a rear monitor.

A character D1 is displayed on a display unit 201 of the information output device 200. The character D1 is a character capable of performing an appearance, an operation, or a performance related to a state of the vehicle C1, and may be, for example, a pseudo-biological character. The pseudo-biological character may be, for example, a character capable of expressing emotions of joy, anger, grief, and pleasure, a character capable of expressing a symptom of a body, for example, a fever symptom or an abdominal pain symptom, or a movable character. The joy, anger, grief, and pleasure are examples of an emotion expression of a human, and includes various emotion expressions such as joy, anger, grief, surprise, fear, dislike, pleasure, and joy.

Specifically, an animal having a deep connection with a human, for example, a dog, or a cat, can be set as the character D1. In the present embodiment, an example in which the character D1 is a dog will be described. A living body other than an animal, for example, a pseudo-biological plant, or an object other than a living body, may be set as the character D1, For example, a robot imitating another animal, a robot imitating an organism of a virtual object (for example, face of animation character), or a robot imitating another object (for example, television device or radio device) may be set as the character D1.

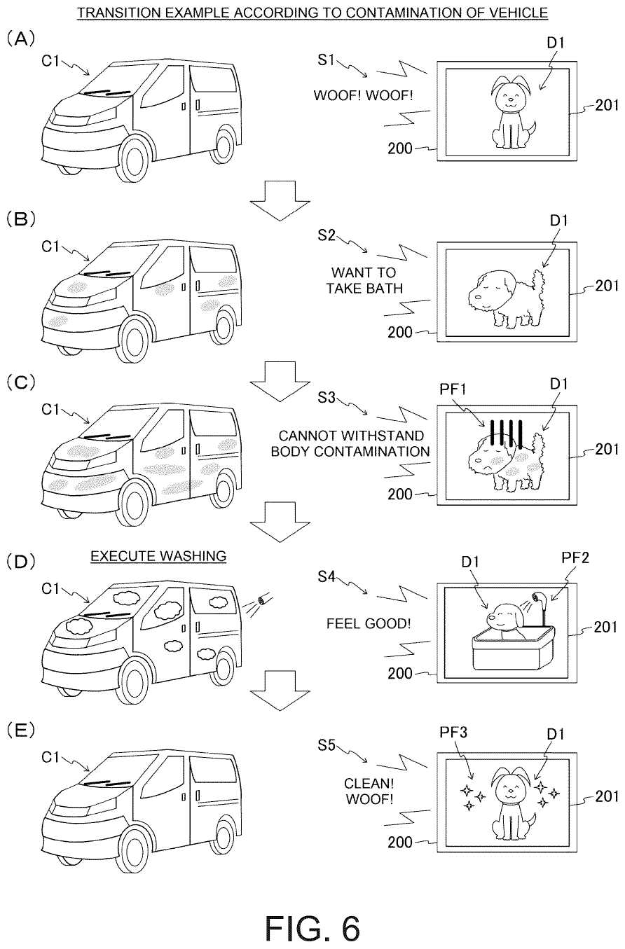

The character D1 has a reference mode as a reference. The reference mode may be, for example, display modes illustrated in FIG. 2 and (A) of FIG. 6, that is, a reference display mode. When the character D1 is displayed in the reference display mode, sound information S1 as a reference may be output as a sound. The sound information S1 is referred to as a reference sound mode as a reference.

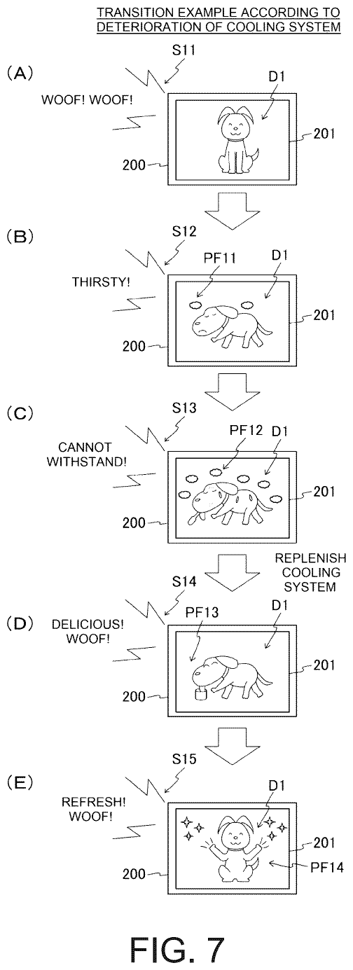

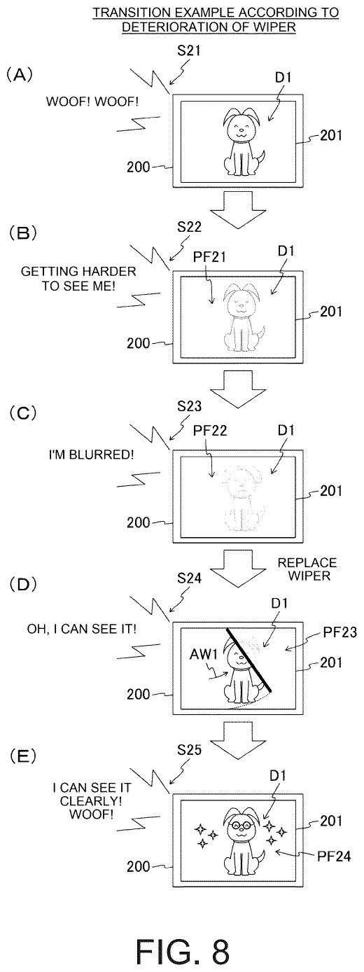

The appearance, the operation, or the performance of the character D1 is determined based on a deterioration degree of the vehicle C1 such as a deterioration degree of a component of the vehicle C1 or a contamination degree of the appearance of the vehicle C1. For example, the appearance, the operation, or the performance of the character D1 is determined as illustrated in (A) to (C) of FIG. 6, (A) to (C) of FIG. 7, and (A) to (C) of FIG. 8.

In addition, the appearance, the operation, or the performance of the character D1 is determined based on execution of maintenance of the vehicle C1. The maintenance of the vehicle C1 is, for example, replacement of a component of the vehicle C1, replenishment of a component of the vehicle C1, cleaning of the vehicle C1, or inspection of the vehicle C1. For example, the appearance, the operation, or the performance of the character D1 is determined as illustrated in (D) and (E) of FIG. 6, (D) and (E) of FIG. 7, and (D) and (E) of FIG. 8.

The character D1 may implement an agent function capable of bidirectional exchange with an occupant of the vehicle C1. For example, the character D1 may execute various functions such as guidance of a destination, provision of neighboring recommended spot information, description of a driving support function provided for the vehicle C1, and various driving supports. The character D1 may implement other functions, for example, a function of a liven-up role and a function of giving a quiz.

### System Configuration Example of Vehicle

FIG. 3 is a block diagram illustrating an example of a functional configuration of an information processing system 1. The information processing system 1 is an information processing system for performing output processing of the character D1 (see FIG. 2).

The information processing system 1 includes an external signal input unit 11, an air pressure sensor 12, a voltage sensor 13, a component state sensor 14, a speed sensor 15, an exterior camera 16, an interior camera 17, a position information acquisition sensor 18, the information processing device 100, and the information output device 200.

The external signal input unit 11 inputs input information received in response to an input operation by a user, input information transmitted from an external device using wired communication or wireless communication, and the like, and outputs the input information to the information processing device 100.

The air pressure sensor 12, the voltage sensor 13, the component state sensor 14, and the speed sensor 15 are various sensors installed in the vehicle C1, and output detection values to the information processing device 100. The sensor illustrated in FIG. 3 is an example of a sensor that may be installed in the vehicle C1, and another sensor may be used. The component state sensor 14 includes, for example, a brake pad wear sensor.

The air pressure sensor 12 is a sensor that detects an air pressure in a tire of the vehicle C1. The voltage sensor 13 is a sensor that detects a voltage of a battery of the vehicle C1. The component state sensor 14 is a sensor that detects a state of each component installed in the vehicle C1. The speed sensor 15 is a sensor that detects a speed of the vehicle C1.

The exterior camera 16 generates an image (image data) by capturing an image of a subject outside the vehicle C1, and outputs the generated image to the information processing device 100. The interior camera 17 generates an image (image data) by capturing an image of a subject inside the vehicle C1, and outputs the generated image to the information processing device 100. The exterior camera 16 and the interior camera 17 are implemented by, for example, one or a plurality of camera devices or image sensors capable of capturing an image of a subject. In this example, an example in which at least two image capturing device of the exterior camera 16 and the interior camera 17 are provided is illustrated, but one or three or more image capturing devices may be provided, and some of images of these image capturing devices may be used.

The position information acquisition sensor 18 acquires position information related to a position where the vehicle C1 is present, and outputs the acquired position information to the information processing device 100. For example, the position information acquisition sensor 18 can be implemented by a global navigation satellite system (GNSS) receiver that acquires position information using GNSS. The position information includes data related to positions such as latitude, longitude, and altitude at the time of receiving a GNSS signal. In addition, the position information may be acquired by another position information acquisition method. For example, the position information may be derived using information from an access point or a base station present in the vicinity of the vehicle C1. In addition, the position information may be acquired using a beacon. In addition, for example, the position information may be derived using a position estimation technique by a navigation device.

The information processing device 100 is a processing device that controls an output state of the information output device 200, and is implemented by a controller such as a central processing unit (CPU). An electronic control unit (ECU) of the vehicle C1 may be used as the information processing device 100, and another control device may be used as the information processing device 100.

The information processing device 100 includes a component state determination unit 101, an elapsed time determination unit 102, a travel distance determination unit 103, a situation determination unit 104, a storage unit 107, a determination unit 108, and an output control unit 109.

The component state determination unit 101 determines the state of each component installed in the vehicle C1 based on information from the air pressure sensor 12, the voltage sensor 13, and the component state sensor 14, and outputs a determination result to the situation determination unit 104. For example, the component state determination unit 101 calculates, as a state of each component, a determination value indicating deterioration to which extent progresses, based on a current value corresponding to a reference value of each component, and outputs the determination value as a determination result.

The elapsed time determination unit 102 calculates an elapsed time for determining the state of each component installed in the vehicle C1, and outputs a calculation result to the situation determination unit 104.

The travel distance determination unit 103 calculates a travel distance of the vehicle C1 based on speed information from the speed sensor 15, and outputs a calculation result to the situation determination unit 104.

The situation determination unit 104 performs various types of situation determination processing based on the information from the external signal input unit 11, the exterior camera 16, the interior camera 17, the position information acquisition sensor 18, the component state determination unit 101, the elapsed time determination unit 102, and the travel distance determination unit 103. Specifically, the situation determination unit 104 includes a deterioration degree determination unit 105 and an execution determination unit 106.

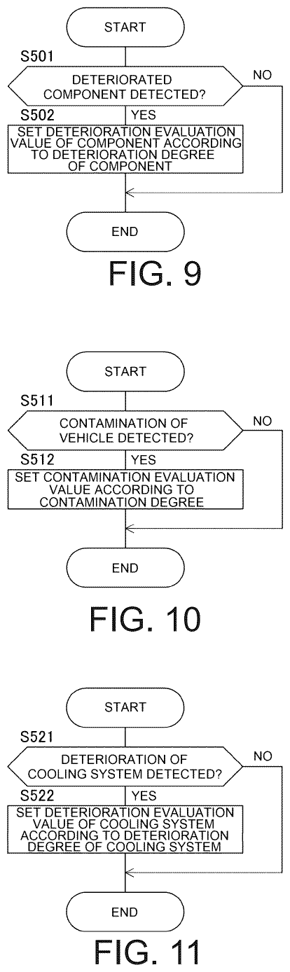

The deterioration degree determination unit 105 determines the deterioration degree of the vehicle C1, stores a determination result in an evaluation value DB 120 of the storage unit 107, and outputs the determination result to the determination unit 108. In the present embodiment, an example in which at least one of the deterioration degree of the component of the vehicle C1 or the contamination degree of the appearance of the vehicle C1 is set as the deterioration degree of the vehicle C1 will be described. Deterioration degree determination processing by the deterioration degree determination unit 105 will be described in detail with reference to FIGS. 9 to 14.

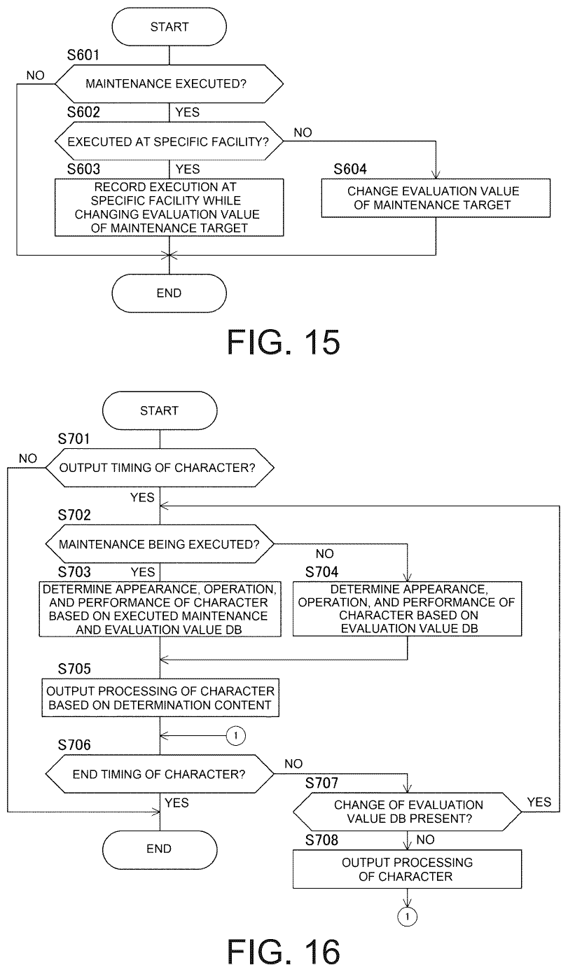

The execution determination unit 106 determines whether maintenance of the vehicle C1 is executed, stores a determination result in a maintenance information DB 130 of the storage unit 107, and outputs the determination result to the determination unit 108. Maintenance execution determination processing by the execution determination unit 106 will be described in detail with reference to FIG. 15.

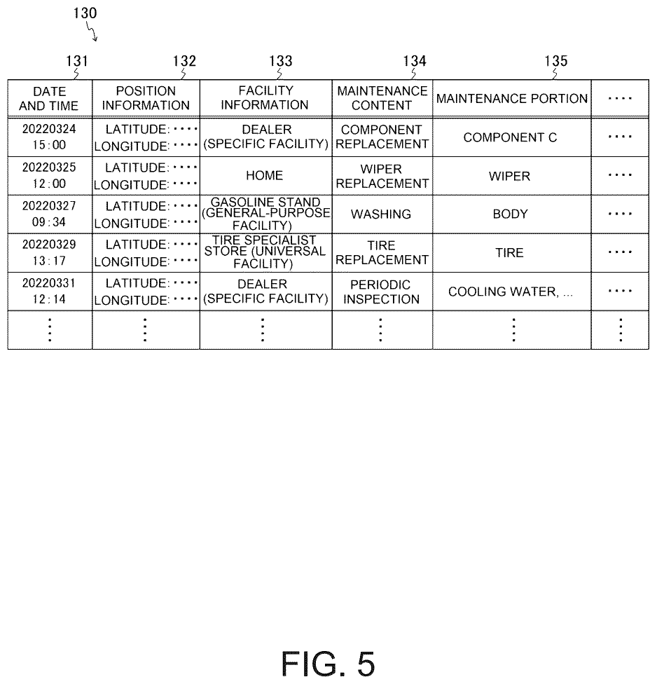

The storage unit 107 is a storage medium that stores various types of information. For example, the storage unit 107 stores various types of information necessary for the information processing device 100 to perform various types of processing (for example, control program, evaluation value DB 120 (see FIG. 4), maintenance information DB 130 (see FIG. 5), and character information DB 140)). As the storage unit 107, for example, a read only memory (ROM), a random access memory (RAM), a hard disk drive (HDD), a solid state drive (SSD), or a combination thereof may be used.

The determination unit 108 determines the appearance, the operation, and the performance of the character D1 (see FIG. 2) output from the information output device 200 based on a determination result by the situation determination unit 104, the evaluation value DB 120, and the maintenance information DB 130. Then, the determination unit 108 outputs the determination content to the output control unit 109. Determination processing by the determination unit 108 will be described in detail with reference to FIG. 16.

The output control unit 109 performs output processing of the character D1 output from the information output device 200 based on the determination content determined by the determination unit 108. The output processing is performed using the character information DB 140 of the storage unit 107. Output control processing by the output control unit 109 will be described in detail with reference to FIG. 16. An output example of the character D1 output from the output control unit 109 is illustrated in FIGS. 6 to 8.

The information output device 200 includes the display unit 201 and sound output unit 202. The display unit 201 is a display panel that displays various images under the control of the information processing device 100. The sound output unit 202 is a speaker that outputs various sounds under the control of the information processing device 100.

### Example of Content of Evaluation Value DB

FIG. 4 is a diagram schematically illustrating information stored in the evaluation value DB 120. The evaluation value DB 120 is a database for managing information for evaluating the deterioration degree of the component of the vehicle C1, the contamination degree of the appearance of the vehicle C1, and the like. The deterioration degree of the component of the vehicle C1 includes the state of the component of the vehicle C1, a capacity of a liquid used in the vehicle C1, for example, oil, or cooling water, and the like.

The evaluation value DB 120 stores evaluation values of a component A 121, a component B 122, a component C 123, vehicle contamination 124, a cooling system 125, wiper deterioration 126, a tire groove 127, and a tire air pressure 128. These components and the like are examples, and evaluation values of other components and the like may be stored in the evaluation value DB 120.

The evaluation values are set by the deterioration degree determination unit 105 based on the sensors, the cameras, and external inputs. In the present embodiment, an example is illustrated in which an evaluation value for which the deterioration degree or the contamination degree is the minimum is set to “0”, and an evaluation value for which the deterioration degree or the contamination degree is most deteriorated is set to “100”. A method for setting each evaluation value will be described in detail with reference to FIGS. 9 to 14.

### Example of Content of Maintenance Information DB

FIG. 5 is a diagram schematically illustrating information stored in the maintenance information DB 130. The maintenance information DB 130 is a database for managing information related to maintenance executed on the vehicle C1. The maintenance executed on the vehicle C1 is, for example, replacement of a component of the vehicle C1, replenishment of a component of the vehicle C1, cleaning of the vehicle C1, or inspection of the vehicle C1. The inspection of the vehicle C1 includes inspection of a tire, an engine room, and the like. The cleaning of the vehicle C1 includes cleaning of the interior of the cabin, washing of the body, and the like.

The maintenance information DB 130 stores date and time 131, position information 132, facility information 133, a maintenance content 134, and a maintenance portion 135 in association with one another. These pieces of information are stored by the execution determination unit 106 based on the sensors, the cameras, and external inputs. These pieces of information are examples, and another piece of information may be stored in the maintenance information DB 130. An acquisition method for the maintenance information will be described in detail with reference to FIG. 15.

### Display Transition Example of Character According to Contamination of Vehicle

FIG. 6 is a diagram illustrating a relation between the contamination degree of the body of the vehicle C1 and the character D1 displayed on the display unit 201 of the information output device 200. FIG. 6 illustrates an example in which the sound information S1 to S5 is output from the sound output unit 202.

In the present embodiment, an example is illustrated in which the character D1 is displayed in any display mode of the reference display mode, a deterioration display mode, a post-maintenance display mode, and a transition performance mode. The reference display mode is a display mode as a reference, and is, for example, a display mode illustrated in (A) of FIG. 6, (A) of FIG. 7, and (A) of FIG. 8.

The deterioration display mode is a display mode in which at least one of the appearance or the operation of the character D1 in the reference display mode is changed based on the deterioration degree of the component of the vehicle C1, the contamination degree of the appearance of the vehicle C1, and the like. For example, an expression of grief without executing maintenance of the vehicle C1 can be set as the deterioration display mode. For example, a mode in which the deterioration state of the vehicle C1 assumed to occur based on the deterioration degree of the component of the vehicle C1, the contamination degree of the appearance of the vehicle C1, and the like is reflected in the character can be set as the deterioration display mode. For example, display modes illustrated in (B) and (C) of FIG. 6, (B) and (C) of FIG. 7, and (B) and (C) of FIG. 8 can be set as the deterioration display mode. In addition, the character D1 may be caused to perform a grief performance to set the deterioration display mode. After execution of the maintenance of the vehicle C1, the character D1 is transitioned from the deterioration display mode to the post-maintenance display mode, and then transitioned from the post-maintenance display mode to the reference display mode.

The post-maintenance display mode is a display mode of the character D1 displayed during transition from the deterioration display mode to the reference display mode after the execution of the maintenance of the vehicle C1. For example, it is possible to set, as the post-maintenance display mode, a joy expression of after the execution of the maintenance of the vehicle C1. In addition, for example, a mode in which a state of the vehicle C1 assumed to occur based on the execution of the maintenance of the vehicle C1, for example, a state of becoming clean or a state where a satisfied state is reflected on the character can be set as the post-maintenance display mode. For example, display modes illustrated in (E) of FIG. 6, (E) of FIG. 7, and (E) of FIG. 8 can be set as the post-maintenance display mode. In addition, the character D1 may be caused to perform a joy performance to set the post-maintenance display mode. In this manner, the post-maintenance display mode may be a mode in which some performance is performed in a background portion of the character D1 in the reference display mode as illustrated in (E) of FIG. 6, or may be a mode in which the appearance or the operation of the character D1 is changed from the reference display mode as illustrated in (E) of FIG. 7 and (E) of FIG. 8.

The transition performance mode is a display mode of the character D1 displayed in a predetermined period until the character D1 transitions from the deterioration display mode to the post-maintenance display mode after the execution of the maintenance of the vehicle C1. For example, in addition to the performance according to the maintenance of the vehicle C1, the joy expression after the execution of the maintenance can be set as the transition performance mode. For example, display modes illustrated in (D) of FIG. 6, (D) of FIG. 7, and (D) of FIG. 8 can be set as the transition display mode. FIGS. 6 to 8 illustrate examples in which the character D1 is set to the transition performance mode during transition of the character D1 from the deterioration display mode to the post-maintenance display mode after the execution of the maintenance of the vehicle C1, but the transition performance mode may be omitted. In this case, the character D1 is transitioned from the deterioration display mode to the post-maintenance display mode after the execution of the maintenance of the vehicle C1.

FIG. 6 illustrates an example in which the appearance, the operation, the performance, and the like of the character D1 are transitioned based on the vehicle contamination 124 (see FIG. 4) of the evaluation value DB 120. For example, (A) of FIG. 6 illustrates an output example of the character D1 when each evaluation value (including vehicle contamination 124) of the evaluation value DB 120 is a value close to “0”, that is, an example of the reference display mode. (B) of FIG. 6 illustrates an output example of the character D1 when the vehicle contamination 124 is a value of about “50” to “60” and other evaluation values are values close to “0”, that is, an example of the deterioration display mode. (C) of FIG. 6 illustrates an output example of the character D1 when the vehicle contamination 124 is a value of about “60” to “80” and other evaluation values are values close to “0”, that is, an example of the deterioration display mode. (D) of FIG. 6 illustrates an output example of the character D1 when washing of the vehicle C1 is detected, that is, an example of the transition performance mode. (E) of FIG. 6 illustrates an output example of the character D1 when the vehicle contamination 124 changes to a value close to “0” due to washing of the vehicle C1, that is, an example of the post-maintenance display mode.

Display information for displaying each image of the character D1 and sound information for outputting each sound of the character D1 are stored in the character information DB 140 (see FIG. 3).

(A) of FIG. 6 illustrates the vehicle C1 in a state where the body is hardly contaminated, and the character D1 in the reference display mode displayed on the display unit 201. As described above, when the character D1 in the reference display mode is displayed on the information output device 200, the sound information S1 as a reference may be output as a sound.

(B) and (C) of FIG. 6 illustrate a relation example between the vehicle C1 in a state where the body is contaminated and the character D1 in the deterioration display mode displayed on the display unit 201. (C) of FIG. 6 illustrates a state where the contamination degree of the body of the vehicle C1 is worse than that in (B) of FIG. 6.

As illustrated in (B) and (C) of FIG. 6, the display mode is transitioned to a display mode in which the body of the character D1 is contaminated as the contamination degree of the body of the vehicle C1 deteriorates, that is, the deterioration display mode. In this case, it is possible to set a display mode in which the body of the character D1 is contaminated due to a change in at least one of the appearance or the operation of the character D1 or the performance related to the character D1 being performed. For example, it is possible to set a display mode in which the number of colored portions of the character D1 is increased as the contamination degree of the body of the vehicle C1 deteriorates. Such contamination coloring may be made translucent, and a density of contamination coloring may be increased as the contamination degree of the body of the vehicle C1 deteriorates. In this manner, contamination coloring processing may be executed on the character D1 in a case where the deterioration degree of the vehicle C1 deteriorates.

The performance related to the character D1 may be performed by performing a change in at least one of the appearance or the operation of the character D1 or a change in a portion other than the appearance and the operation of the character D1, for example, a background portion. For example, it is possible to perform a performance of providing an appearance in which the hair of the character D1 is contaminated and stands up, as illustrated in (B) of FIG. 6. In addition, it is possible to express a dog of which the emotion of grief appears by providing an appearance in which the hair of the character D1 is further contaminated and performing a performance PF1 in which a face portion of the character D1 and a background portion are superimposed and displayed by vertical lines, as illustrated in (C) of FIG. 6. The emotion of grief may be expressed by anger, dislike, or the like.

In addition, it is possible to output, as the sound made by the character D1, the sound information S2 and S3 indicating the grief for the contamination as the contamination degree of the body of the vehicle C1 deteriorates, as illustrated in (B) and (C) of FIG. 6. Accordingly, it is possible to cause the user of the vehicle C1 to visually and audibly recognize the grief of the body of the character D1 being contaminated. In this manner, it is possible for the user to enhance the attachment to the character D1 and to enhance the awareness to actively take care of the character D1 by feeling the character D1 of which the body is contaminated and the emotion of grief becomes high. Accordingly, it is possible to enhance the attachment to the vehicle C1 related to the character D1 and to enhance the initiative to actively manage the vehicle C1. Accordingly, it is possible to prevent a delay in maintenance of the vehicle C1, that is, washing.

(D) of FIG. 6 illustrates a relation example between the vehicle C1 in a state where the body is being washed and the character D1 in the transition performance mode displayed on the display unit 201. An execution determination method of the washing of the vehicle C1 will be described in detail with reference to FIG. 15.

Here, in the present embodiment, a period until a predetermined time elapses after execution of the washing of the body of the vehicle C1 is determined will be described as a period during which the washing is being executed. Similarly for execution of other maintenance, a period until a predetermined time elapses after execution of the maintenance is determined will be described as a period during which the maintenance is being executed. That is, deviation may occur between a period during which maintenance is actually executed and an execution period used for the output processing of the character D1. The predetermined time shown here may be, for example, a value of about several minutes to several tens of minutes. In addition, the predetermined time may be changed according to a content of the executed maintenance. For example, in the case of maintenance in which an execution time is relatively long, a long value can be set as the predetermined time, and in the case of maintenance in which the execution time is relatively short, a short value can be set as the predetermined time. The predetermined time may be set based on the position information. For example, when the vehicle C1 is present in a car wash, a period during which the vehicle C1 stays in the car wash can be set as the predetermined time. In addition, for example, when the vehicle C1 is present in a maintenance factory, a period during which the vehicle C1 stays in the maintenance factory can be set as the predetermined time.

As illustrated in (D) of FIG. 6, when the washing of the vehicle C1 of which the body is contaminated is executed, a transition is made to a performance FP2 in which the dog of the character D1 is showering in the bath. In this manner, the performance FP2 according to the execution of the washing of the vehicle C1 is performed using a background image of the character D1 together with the appearance and the operation of the character D1. It is possible to output, as the sound made by the character D1, the sound information S4 indicating an emotion of joy that the bath is comfortable.

Accordingly, the user who executes a washing work of the vehicle C1 can grasp that the dog of the character D1 feels better by the washing work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. Since it can be seen that the dog of the character D1 feels good every time the washing work is executed, it is possible to increase the frequency of the washing work, and it is possible to prevent a delay in washing the vehicle C1.

(E) of FIG. 6 illustrates a relation example between the vehicle C1 in a state where the washing of the body is ended and the character D1 in the post-maintenance display mode displayed on the display unit 201.

As illustrated in (E) of FIG. 6, after the washing of the vehicle C1 is ended, the display mode is transitioned to a performance mode in which the dog of the character D1 becomes clean by the bath, that is, the post-maintenance display mode. In this manner, a performance PF3 of the dog that becomes clean according to the execution of the washing of the vehicle C1 is performed using the background image of the character D1 in addition to the appearance and the operation of the character D1. In addition, it is possible to output, as the sound made by the character D1, the sound information S5 indicating the emotion of joy of becoming clean by the bath.

Accordingly, the user who executes the washing work of the vehicle C1 can grasp that the dog of the character D1 becomes clean by the washing work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. Since it can be seen that the dog of the character D1 becomes clean every time the washing work is executed, it is possible to increase the frequency of the washing work, and it is possible to prevent a delay in washing the vehicle C1.

The post-maintenance display mode illustrated in (E) of FIG. 6 is returned to the reference display mode at a predetermined timing. The predetermined timing may be, for example, a timing at which a predetermined time elapses after the end of the washing of the body. The predetermined time may be, for example, about several minutes to several tens of minutes. Accordingly, since the user can see the performance modes or the like illustrated in (D) and (E) of FIG. 6 every time the washing of the body is executed, it is possible to enhance the awareness of the user to actively manage the vehicle C1. In this example, the performance modes illustrated in (D) and (E) of FIG. 6 are executed when the washing of the vehicle C1 is executed after the body of the vehicle C1 is contaminated, but the performance modes illustrated in (D) and (E) of FIG. 6 may be executed even when the washing of the vehicle C1 is executed in a case where the body of the vehicle C1 is not contaminated. That is, various performances according to the execution of the maintenance are performed even when the state before the maintenance is not bad.

### Display Transition Example of Character According to Deterioration of Cooling System

FIG. 7 is a diagram illustrating a relation between a deterioration degree of a cooling system of the vehicle C1 and the character D1 displayed on the display unit 201 of the information output device 200. FIG. 7 illustrates an example in which sound information S11 to S15 is output from the sound output unit 202. Here, the deterioration degree of the cooling system of the vehicle C1 indicates a deterioration degree of a component or a refrigerant related to the cooling system of the vehicle C1. The refrigerant is, for example, cooling water.

FIG. 7 illustrates an example in which the appearance, the operation, the performance, and the like of the character D1 are transitioned based on the cooling system 125 (see FIG. 4) of the evaluation value DB 120. For example, (A) of FIG. 7 illustrates an output example of the character D1 when each evaluation value (including cooling system 125) of the evaluation value DB 120 is a value close to “0”, that is, an example of the reference display mode. (B) of FIG. 7 illustrates an output example of the character D1 when the cooling system 125 is a value of about “50” to “60” and other evaluation values are values close to “0”, that is, an example of the deterioration display mode. (C) of FIG. 7 illustrates an output example of the character D1 when the cooling system 125 is a value of about “60” to “80” and other evaluation values are values close to “0”, that is, an example of the deterioration display mode. (D) of FIG. 7 illustrates an output example of the character D1 when replenishment of the cooling system is detected, that is, an example of the transition performance mode. (E) of FIG. 7 illustrates an output example of the character D1 when the cooling system 125 changes to a value close to “0” due to the replenishment of the cooling system, that is, an example of the post-maintenance display mode.

(A) of FIG. 7 illustrates the character D1 in the reference display mode displayed on the display unit 201 in a state where the component or the refrigerant related to the cooling system is hardly deteriorated. As described above, the sound information S11 as a reference may be output as the sound when the character D1 in the reference display mode is displayed on the information output device 200.

(B) and (C) of FIG. 7 illustrate display examples of the character D1 in the deterioration display mode displayed on the display unit 201 in a state where the component or the refrigerant related to the cooling system is deteriorated. (C) of FIG. 7 illustrates a state where the deterioration degree of the component or the refrigerant related to the cooling system is worse than that of (B) of FIG. 7.

As illustrated in (B) and (C) of FIG. 7, as the deterioration degree of the component or the refrigerant related to the cooling system deteriorates, the display mode is transitioned to a display mode in which the character D1 is caused to express a specific symptom, that is, the deterioration display mode. (B) and (C) of FIG. 7 illustrate examples of a display mode in which the character D1 is caused to express a fever symptom. In this case, it is possible to set a display mode in which the character D1 is caused to express a fever symptom due to a change in at least one of the appearance or the operation of the character D1 or the performance related to the character D1 being performed. For example, it is possible to set a display mode in which the movement speed of the character D1 decreases or a display mode in which the movement amount of the character D1 decreases.

Similarly to FIG. 6, it is possible to perform the change in at least one of the appearance or the operation of the character D1 or the performance related to the character D1 by a change in a portion other than the appearance and the operation of the character D1, for example, a background portion. For example, it is possible to perform a performance PF11 in which a cloud-shaped object indicating a perspiration state appears around the character D1, as illustrated in (B) of FIG. 7. In addition, it is possible to express a dog which expresses an emotion of grief, such as pain of fever, by performing a performance PF12 in which the number of clouds is further increased, a large amount of sweat is emitted, and a dog thermometer is held in its mouth, as illustrated in (C) of FIG. 7.

In addition, it is possible to output, as the sound made by the character D1, the sound information S12 and S13 indicating the grief of fever as the deterioration degree of the component or the refrigerant related to the system deteriorates, as illustrated in (B) and (C) of FIG. 7. Accordingly, the user of the vehicle C1 can visually and audibly recognize the grief of fever of the character D1. In this manner, the user can enhance the attachment to the character D1 and can enhance the awareness to actively take care of the character D1 by feeling the character D1 of which the emotion of grief becomes high due to fever. Accordingly, it is possible to enhance the attachment to the vehicle C1 related to the character D1 and to enhance the initiative to actively manage the vehicle C1. Accordingly, it is possible to prevent a delay in maintenance of the vehicle C1, that is, replacement or replenishment of the cooling system.

(D) of FIG. 7 illustrates a display example of the character D1 in the transition performance mode displayed on the display unit 201 after execution of the replenishment of the cooling system of the vehicle C1. An execution determination method of the replenishment of the cooling system will be described in detail with reference to FIG. 15.

As illustrated in (D) of FIG. 7, when replacement or replenishment of the component or the refrigerant related to the cooling system is executed, the display mode is transitioned to a performance mode in which the character D1 is drinking a drink such as cooling water, that is, the transition performance mode. In this manner, a performance PF13 according to execution of the replacement or replenishment of the component or the refrigerant related to the cooling system is performed using the background image of the character D1 in addition to the appearance and the operation of the character D1. In addition, it is possible to output, as the sound made by the character D1, the sound information S14 indicating the emotion of joy of drinking a drink and tasting good.

Accordingly, the user who executes a replacement work or a replenishment work of the component or the refrigerant related to the cooling system can grasp that the dog of the character D1 is given a drink and refreshed due to the replacement work or the replenishment work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. Since the dog of the character D1 can be given a drink and refreshed each time the replacement work or the replenishment work is executed, it is possible to increase the frequency of the replacement work or the replenishment work, and it is possible to prevent a delay in replacement or replenishment with respect to the vehicle C1.

(E) of FIG. 7 illustrates a display example of the character D1 in the post-maintenance display mode displayed on the display unit 201 after the replacement or replenishment of the component or the refrigerant related to the cooling system is ended.

As illustrated in (E) of FIG. 7, after the replacement or replenishment of the component or the refrigerant related to the cooling system is ended, the display mode is transitioned to a performance mode in which the dog of the character D1 is refreshed, that is, the post-maintenance display mode. In this manner, a performance PF14 of the dog which is refreshed in response to execution of the replacement or replenishment of the component or the refrigerant related to the cooling system is executed using the background image of the character D1 in addition to the appearance and the operation of the character D1. In addition, it is possible to output, as the sound made by the character D1, the sound information S15 indicating the emotion of joy of being refreshed. Similarly to FIG. 6, the post-maintenance display mode illustrated in (E) of FIG. 7 is returned to the reference display mode at a predetermined timing. In addition, various performances according to the execution of the maintenance may be performed even when the state before the maintenance is not bad.

Accordingly, the user who executes the replacement work or the replenishment work of the component or the refrigerant related to the cooling system can grasp that the dog of the character D1 is refreshed due to the replacement work or the replenishment work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. In addition, since it can be seen that the dog of the character D1 is refreshed every time the replacement work or the replenishment work is executed, it is possible to increase the frequency of the replacement work or the replenishment work, and it is possible to prevent a delay in replacement or replenishment with respect to the vehicle C1.

### Display Transition Example of Character According to Wiper Deterioration

FIG. 8 is a diagram illustrating a relation between a deterioration degree of a wiper of the vehicle C1 and the character D1 displayed on the display unit 201 of the information output device 200. FIG. 8 illustrates an example in which sound information S21 to S25 is output from the sound output unit 202.

FIG. 8 illustrates an example in which the appearance, the operation, the performance, and the like of the character D1 are transitioned based on the wiper deterioration 126 (see FIG. 4) of the evaluation value DB 120. For example, (A) of FIG. 8 illustrates an output example of the character D1 when each evaluation value (including wiper deterioration 126) of the evaluation value DB 120 is a value close to “0”, that is, an example of the reference display mode. (B) of FIG. 8 illustrates an output example of the character D1 when the wiper deterioration 126 is a value of about “50” to “60” and other evaluation values are values close to “0”, that is, an example of the deterioration display mode. (C) of FIG. 8 illustrates an output example of the character D1 when the wiper deterioration 126 is a value of about “60” to “80” and other evaluation values are values close to “0”, that is, an example of the deterioration display mode. (D) of FIG. 8 illustrates an output example of the character D1 when wiper replacement is detected, that is, an example of the transition performance mode. (E) of FIG. 8 illustrates an output example of the character D1 when the wiper deterioration 126 changes to a value close to “0” due to wiper replacement, that is, an example of the post-maintenance display mode.

(A) of FIG. 8 illustrates the character D1 in the reference display mode displayed on the display unit 201 in a state where the wiper is hardly deteriorated. As described above, when the character D1 in the reference display mode is displayed on the information output device 200, the sound information S21 as a reference may be output as the sound.

(B) and (C) of FIG. 8 illustrate display examples of the character D1 in the deterioration display mode displayed on the display unit 201 in a state where the wiper is deteriorated. (C) of FIG. 8 illustrates a state where the deterioration degree of the wiper is worse than in (B) of FIG. 8.

As illustrated in (B) and (C) of FIG. 8, as the deterioration degree of the wiper deteriorates, the display mode is transitioned to a display mode in which a display screen displaying the character D1 is gradually blurred, that is, the deterioration display mode. (B) and (C) of FIG. 8 illustrate examples of the display mode in which the character D1 itself is gradually blurred. In this case, it is possible to set a display mode in which the character D1 itself is blurred by performing a change in at least one of the appearance or the operation of the character D1 or the performance related to the character D1. In this manner, it is possible to set a display mode in which the appearance of the character D1 becomes unclear according to the deterioration degree of the component of the vehicle C1. The display mode may be such that the appearance of the character D1 becomes unclear due to processing of blurring an outline of the character D1, processing of reducing a color degree or contrast, or the like.

Similarly to FIG. 6, it is possible to perform the change in at least one of the appearance or the operation of the character D1 or the performance related to the character D1 by a change in a portion other than the appearance and the operation of the character D1, for example, a background portion. For example, it is possible to perform performances PF21 and PF22 in which both the character D1 itself and the surroundings are blurred, as illustrated in (B) and (C) of FIG. 8.

In addition, it is possible to output, as the sound made by the character D1, the sound information S22 and S23 indicating the grief for invisibility itself as the deterioration degree of the wiper deteriorates, as illustrated in (B) and (C) of FIG. 8. Accordingly, the user of the vehicle C1 can visually and audibly recognize the grief for invisibility of the character D1. In this manner, the user can enhance the attachment to the character D1 and can enhance the awareness to actively take care of the character D1 by feeling the character D1 of which the emotion of grief becomes high due to invisibility itself. Accordingly, it is possible to enhance the attachment to the vehicle C1 related to the character D1 and to enhance the initiative to actively manage the vehicle C1. Accordingly, it is possible to prevent a delay in maintenance of the vehicle C1, that is, wiper replacement.

(D) of FIG. 8 illustrates a display example of the character D1 in the transition performance mode displayed on the display unit 201 after execution of the wiper replacement of the vehicle C1. An execution determination method of the wiper replacement will be described in detail with reference to FIG. 15.

As illustrated in (D) of FIG. 8, the display mode is transitioned to the transition performance mode in which the wiper moves in front of the blurred character D1 in a direction of an arrow AW1 to make the display screen clean when the wiper replacement is executed. In this manner, a performance PF23 according to execution of the wiper replacement is performed using a background image of the character D1 together with the appearance and the operation of the character D1. In addition, it is possible to output, as the sound made by the character D1, the sound information S24 indicating an emotion of joy that the character D1 is clearly seen and is happy.

Accordingly, the user who executes the wiper replacement can grasp that the dog of the character D1 is clearly seen due to the wiper replacement work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. In addition, since the dog of the character D1 can be clearly seen every time the wiper replacement work is executed, it is possible to increase the frequency of the wiper replacement work, and it is possible to prevent a delay in wiper replacement.

(E) of FIG. 8 illustrates a display example of the character D1 in the post-maintenance display mode displayed on the display unit 201 after the wiper replacement is ended.

As illustrated in (E) of FIG. 8, the display mode is transitioned to a performance mode in which the dog of the character D1 is clearly seen, that is, the post-maintenance display mode, after the wiper replacement is ended. In this manner, a performance PF24 of the dog which is clearly seen according to execution of the wiper replacement is performed using a background image of the character D1 together with the appearance and the operation of the character D1. In addition, it is possible to output, as the sound made by the character D1, the sound information S25 indicating the emotion of joy of being clearly seen.

Accordingly, the user who executes the wiper replacement work can grasp that the dog of the character D1 is clearly seen due to the wiper replacement work. Accordingly, the sense of intimacy and the attachment to the dog of the character D1 are enhanced, and the sense of intimacy and the attachment to the vehicle C1 related to the character D1 are also enhanced. In addition, it is possible to enhance the awareness of the user to actively manage the vehicle C1. In addition, since the dog of the character D1 can be clearly seen every time the wiper replacement work is executed, it is possible to increase the frequency of the wiper replacement work, and it is possible to prevent a delay in wiper replacement.

### Operation Example of Information Processing Device

Next, an operation of determination processing of determining the deterioration degree of the component of the vehicle C1, the contamination degree of the appearance of the vehicle C1, and the like will be described.

### Operation Example of Deteriorated Component Determination Processing

FIG. 9 is a flowchart illustrating an example of deteriorated component determination processing in the information processing device 100. The deteriorated component determination processing is performed based on a program stored in the storage unit 107. The deteriorated component determination processing is always performed in each control cycle. The deteriorated component determination processing will be described with reference to FIGS. 1 to 8 as appropriate.

In step S501, the deterioration degree determination unit 105 determines whether a deteriorated component is detected from the components constituting the vehicle C1. Specifically, the deterioration degree determination unit 105 detects a deteriorated component from the components constituting the vehicle C1 based on the information from the external signal input unit 11, the exterior camera 16, the interior camera 17, the component state determination unit 101, the elapsed time determination unit 102, and the travel distance determination unit 103.

For example, it is known that the quality of each component constituting the vehicle C1 deteriorates with time. Therefore, a replacement period as a standard, for example, a recommended replacement period is set for each component. Thus, the deterioration degree determination unit 105 may calculate the deterioration degree of the component based on elapsed time from the time of component replacement and the replacement period as a standard based on time information from the elapsed time determination unit 102. The time of component replacement may be acquired from the maintenance information DB 130.

For example, when the replacement period as a standard is two years and the elapsed time from the time of component replacement is one year, 50% (one year/two years) is calculated as the deterioration degree of the component. The time of component replacement may be acquired based on the date and time 131 and the maintenance portion 135 (see FIG. 5) of the maintenance information 130. This calculation method is a method of calculating the deterioration degree for changing the display mode of the character D1, and does not determine the replacement period of the component in detail. In this example, the deterioration degree is O when the elapsed time from the time of the component replacement is 0, that is, immediately after the component replacement, and the deterioration degree is 100% when the elapsed time from the time of the component replacement exceeds the replacement period as a standard.

The deterioration degree of the component may be calculated using a travel distance, instead of the elapsed time. For example, the replacement period as a standard, for example, the recommended exchange distance is set for each component. Thus, the deterioration degree determination unit 105 may calculate the deterioration degree of the component based on a travel distance from the time of component replacement and an exchange distance as a standard based on the travel distance information from the travel distance determination unit 103. For example, when the exchange distance as a standard is 300 km and the travel distance from the time of component replacement is 150 km, 50% (150 km/300 km) is calculated as the deterioration degree of the component. This calculation method is a method of calculating the deterioration degree for changing the display mode of the character D1, and does not determine the replacement period of the component in detail. In this example, the deterioration degree is 0 when the travel distance from the time of component replacement is 0, that is, immediately after the replacement, and the deterioration degree is 100% when the travel distance from the time of component replacement exceeds the exchange distance as a standard.

The deterioration degree determination unit 105 may calculate, for a component whose component state may be determined by each sensor, the deterioration degree of the component based on information from the component state determination unit 101. When information related to the deterioration degree of the component is input to the external signal input unit 11 by a user operation, transmission from an external device, or the like, the deterioration degree determination unit 105 may calculate the deterioration degree of the component based on the input information. In the case of a component for which deterioration may be determined by the appearance, the deterioration degree determination unit 105 may calculate the deterioration degree of the component based on a captured image captured by the exterior camera 16 or the interior camera 17. For example, the deterioration degree of the component may be determined by performing prediction processing such as deterioration prediction using the captured image and artificial intelligence (AI).

For example, a component whose deterioration degree exceeds a predetermined value, for example, 50% to 60% is detected as the deteriorated component. When the deteriorated component is detected, the process proceeds to step S502. On the other hand, when the deteriorated component is not detected, the operation of the deteriorated component determination processing is ended.

In step S502, the deterioration degree determination unit 105 sets a deterioration evaluation value of the component according to the deterioration degree of the component detected in step S501. For example, a value of the deterioration degree of the component calculated in step S501 can be set as the deterioration evaluation value. For example, when the component A 121 (see FIG. 4) is detected as the deteriorated component in step S501 and 54% is calculated as the deterioration degree of the component A 121, “54” is stored in the component A 121 (see FIG. 4) of the evaluation value DB 120.

In this manner, when the deterioration evaluation value of the component increases, a contamination expression of the character D1 is deteriorated according to the deterioration evaluation value. For example, the contamination expression of the character D1 can be deteriorated, as illustrated in (B) and (C) of FIG. 6. Grief may be expressed by a fatigue expression or the like instead of the contamination expression.

### Operation Example of Contamination Determination Processing of Vehicle

FIG. 10 is a flowchart illustrating an example of contamination determination processing of the vehicle C1 in the information processing device 100. The contamination determination processing of the vehicle C1 is performed based on a program stored in the storage unit 107. The contamination determination processing of the vehicle C1 is always performed in each control cycle. The contamination determination processing of the vehicle C1 will be described with reference to FIGS. 1 to 9 as appropriate.

In step S511, the deterioration degree determination unit 105 determines whether contamination of the appearance of the vehicle C1 is detected. Specifically, the deterioration degree determination unit 105 detects the contamination of the appearance of the vehicle C1 based on the information from the external signal input unit 11, the exterior camera 16, the interior camera 17, the component state determination unit 101, the elapsed time determination unit 102, and the travel distance determination unit 103.

For example, it is known that the body of the vehicle C1 is contaminated with time. Therefore, it is possible to set a washing period as a standard, for example, one month, after the body of the vehicle C1 is washed. Thus, the elapsed time determination unit 102 may calculate the contamination degree of the appearance of the vehicle C1 based on elapsed time from the time of body washing of the vehicle C1 and the washing period as a standard. For example, when the replacement period as a standard is one month and the elapsed time from the washing is 20 days, 66% (20 days/30 days) is calculated as the contamination degree of the appearance of the vehicle C1. The time of body washing of the vehicle C1 may be acquired based on the date and time 131 and the maintenance portion 135 (see FIG. 5) of the maintenance information 130. This calculation method is a method of calculating the contamination degree of the appearance of the vehicle C1 for changing the display mode of the character D1, and does not determine the washing period in detail. In this example, the contamination degree is 0 when the elapsed time from the time of washing is 0, that is, immediately after the washing, and the contamination degree is 100% when the elapsed time from the time of washing exceeds the washing period as a standard.

As illustrated in FIG. 9, the contamination degree may be calculated using the travel distance instead of the elapsed time, or the contamination degree may be calculated based on the information from the component state determination unit 101. When information related to the contamination of the vehicle C1 is input to the external signal input unit 11 by a user operation, transmission from an external device, or the like, the deterioration degree determination unit 105 may calculate the contamination degree based on the input information.

Since the contamination of the vehicle C1 may be determined by the appearance, the deterioration degree determination unit 105 may calculate the deterioration degree of the component based on the captured image captured by the exterior camera 16 or the interior camera 17. For example, a captured image of the body of the vehicle C1 immediately after the washing is acquired by the exterior camera 16 and stored in the storage unit 107. Then, captured images of the body of the vehicle C1 are sequentially acquired by the exterior camera 16, and the acquired captured images are compared with the captured image stored in the storage unit 107. The contamination of the body of the vehicle C1 may be determined based on whether a difference value between the captured image of the body of the vehicle C1 immediately after the replacement and the captured image acquired thereafter is equal to or greater than a predetermined value based on a comparison result. For example, the contamination degree may be determined by performing prediction processing such as contamination prediction using the captured image and artificial intelligence.

For example, when the contamination degree exceeds a predetermined value, for example, 50% to 60%, the contamination of the appearance of the vehicle C1 is detected. When the contamination of the appearance of the vehicle C1 is detected, the process proceeds to step S512. On the other hand, when the contamination of the appearance of the vehicle C1 is not detected, the operation of the contamination determination processing is ended.

In step S512, the deterioration degree determination unit 105 sets a contamination evaluation value of the vehicle C1 according to the contamination degree of the vehicle C1 detected in step S511. For example, a value of the contamination degree of the vehicle C1 calculated in step S511 can be set as the contamination evaluation value. For example, when 58% is calculated as the contamination degree of the vehicle C1 in step S511, “58” is stored in the vehicle contamination 124 (see FIG. 4) of the evaluation value DB 120.

In this manner, when the contamination evaluation value of the vehicle C1 increases, the contamination expression of the character D1 is deteriorated according to the contamination evaluation value. For example, fatigue and contamination expressions of the character D1 can be deteriorated, as illustrated in (B) and (C) of FIG. 6.

In this example, the contamination of the appearance of the vehicle C1 is determined, but contamination of the interior of the cabin of the vehicle C1 may be determined, and the display mode of the character D1 may be changed using a determination result.

### Operation Example of Cooling System Deterioration Determination Processing

FIG. 11 is a flowchart illustrating an example of cooling system deterioration determination processing in the information processing device 100. The cooling system deterioration determination processing is performed based on a program stored in the storage unit 107. The cooling system deterioration determination processing is always performed in each control cycle. The cooling system deterioration determination processing will be described with reference to FIGS. 1 to 10 as appropriate.

In step S521, the deterioration degree determination unit 105 determines whether deterioration of the component or the refrigerant related to the cooling system among the components constituting the vehicle C1 is detected. Specifically, the deterioration degree determination unit 105 detects the deterioration of the component or the refrigerant related to the cooling system based on the information from the external signal input unit 11, the component state determination unit 101, the elapsed time determination unit 102, and the travel distance determination unit 103.

For example, it is possible to determine the deterioration of the component or the refrigerant related to the cooling system using the elapsed time or the travel distance, similarly to FIGS. 9 and 10. An elapsed time of a high temperature equal to or higher than a predetermined value may be used as the elapsed time by using a history of the temperature of the refrigerant. When information related to the deterioration of the component or the refrigerant related to the cooling system is input to the external signal input unit 11 by a user operation, transmission from an external device, or the like, the deterioration degree determination unit 105 may calculate the deterioration degree of the component or the refrigerant related to the cooling system based on the input information. Since it is possible to determine the state of the component or the refrigerant by each sensor of the component or the refrigerant related to the cooling system, the deterioration degree determination unit 105 may calculate the deterioration degree of the component or the refrigerant based on the information from the component state determination unit 101.

For example, it is assumed that for a component whose deterioration degree exceeds a predetermined value, for example, 50% to 60%, deterioration of the component or the refrigerant related to the cooling system is detected. When deterioration of the component or the refrigerant related to the cooling system is detected, the process proceeds to step S522. On the other hand, when deterioration of the component or the refrigerant related to the cooling system is not detected, the operation of the cooling system deterioration determination processing is ended.

In step S522, the deterioration degree determination unit 105 sets a deterioration evaluation value of the component or the refrigerant related to the cooling system according to the deterioration degree of the component or the refrigerant detected in step S521. For example, a value of the deterioration degree of the component or the refrigerant calculated in step S521 can be set as the deterioration evaluation value. For example, when deterioration of the refrigerant is detected in step S521 and 63% is calculated as the deterioration degree of the refrigerant, “63” is stored in the cooling system 125 (see FIG. 4) of the evaluation value DB 120.

In this manner, when the deterioration evaluation value of the cooling system increases, the character D1 is caused to express a specific symptom according to the deterioration evaluation value, that is, the deterioration display mode. For example, it is possible to cause the character D1 to express a fever symptom, as illustrated in (B) and (C) of FIG. 7. In addition, the frequency of fever of the character D1 may be increased according to deterioration of the deterioration evaluation value of the cooling system.

### Operation Example of Wiper Deterioration Determination Processing

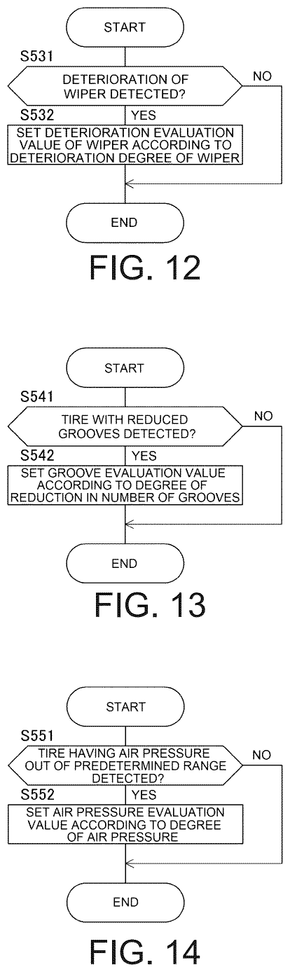

FIG. 12 is a flowchart illustrating an example of wiper deterioration determination processing in the information processing device 100. The wiper deterioration determination processing is performed based on a program stored in the storage unit 107. The wiper deterioration determination processing is always performed in each control cycle. The wiper deterioration determination processing will be described with reference to FIGS. 1 to 11.

In step S531, the deterioration degree determination unit 105 determines whether deterioration of the wiper is detected. Specifically, the deterioration degree determination unit 105 detects the deterioration of the wiper based on the information from the external signal input unit 11, the exterior camera 16, the interior camera 17, the component state determination unit 101, the elapsed time determination unit 102, and the travel distance determination unit 103.

For example, the deterioration of the wiper may be determined using the elapsed time or the travel distance, similarly to FIGS. 9 and 10. An elapsed time of the wiper in an ON state may be used as the elapsed time. The time of wiper replacement may be acquired based on the date and time 131 and the maintenance portion 135 (see FIG. 5) of the maintenance information 130. When information related to the deterioration of the wiper is input to the external signal input unit 11 by a user operation, transmission from an external device, or the like, the deterioration degree determination unit 105 may calculate a deterioration degree of the wiper based on the input information. When the state of the wiper may be determined by each sensor related to the wiper, the deterioration degree determination unit 105 may calculate the deterioration degree of the wiper based on the information from the component state determination unit 101.

The deterioration of the wiper may be determined by using the exterior camera 16 or the interior camera 17 which is capable of acquiring a captured image of the wiper. For example, a captured image of the wiper immediately after the replacement is acquired by the exterior camera 16 and stored in the storage unit 107. Then, captured images of the wiper are sequentially acquired by the exterior camera 16, and the acquired captured images are compared with the captured image stored in the storage unit 107. The deterioration of the wiper may be determined based on whether a difference value between the captured image of the wiper immediately after the replacement and the captured image acquired thereafter is equal to or greater than a predetermined value based on a comparison result. For example, the deterioration degree of the wiper may be determined by performing prediction processing such as wiper deterioration prediction using the captured image and artificial intelligence.

For example, when the deterioration degree exceeds a predetermined value, for example, 50% to 60%, deterioration of the wiper is detected. When the deterioration of the wiper is detected, the process proceeds to step S532. On the other hand, when the deterioration of the wiper is not detected, the operation of the wiper deterioration determination processing is ended.

In step S532, the deterioration degree determination unit 105 sets a deterioration evaluation value of the wiper according to the deterioration degree of the wiper detected in step S531. For example, a value of the deterioration degree of the component or the refrigerant calculated in step S531 can be set as the deterioration evaluation value. For example, when 87% is calculated as the deterioration degree of the wiper in step S531, “87” is stored in the wiper deterioration 126 (see FIG. 4) of the evaluation value DB 120.

In this manner, when the deterioration evaluation value of the wiper increases, a performance is performed such that the display screen displaying the character D1 is gradually blurred according to the deterioration evaluation value. For example, it is possible to perform a performance in which the character D1 itself is blurred, as illustrated in (B) and (C) of FIG. 8.

### Operation Example of Tire Groove Determination Processing

FIG. 13 is a flowchart illustrating an example of tire groove determination processing in the information processing device 100. The tire groove determination processing is performed based on a program stored in the storage unit 107. The tire groove determination processing is always performed in each control cycle. The tire groove determination processing will be described with reference to FIGS. 1 to 12 as appropriate.

In step S541, the deterioration degree determination unit 105 determines whether a tire with reduced grooves is detected. Specifically, the deterioration degree determination unit 105 detects a tire with reduced grooves based on the information from the external signal input unit 11, the exterior camera 16, the component state determination unit 101, the elapsed time determination unit 102, and the travel distance determination unit 103.

For example, it is possible to determine a tire with reduced grooves by using the elapsed time or the travel distance, similarly to FIGS. 9 and 10. When information related to the tire is input to the external signal input unit 11 by a user operation, transmission from an external device, or the like, the deterioration degree determination unit 105 may calculate a degree of reduction in the number of grooves of the tire based on the input information. When the state of the tire may be determined by each sensor related to the tire, the deterioration degree determination unit 105 may calculate the degree of reduction in the number of grooves of the tire based on the information from the component state determination unit 101. For example, the degree of reduction in the number of grooves of the tire may be detected using a sensor that detects the groove of the tire.

The degree of reduction in the number of grooves of the tire may be determined using the exterior camera 16 which is capable of acquiring a captured image of the tire. For example, a captured image of the tire immediately after the replacement is acquired by the exterior camera 16 and stored in the storage unit 107. Then, captured images of the tire are sequentially acquired by the exterior camera 16, and the acquired captured images are compared with the captured image stored in the storage unit 107. The degree of reduction in the number of grooves of the tire may be determined based on whether a difference value between the captured image of the wiper immediately after the replacement and the captured image acquired thereafter is equal to or greater than a predetermined value based on a comparison result. For example, the degree of reduction in the number of grooves of the tire may be determined by performing prediction processing such as prediction of reduction in the number of grooves of the tire using the captured image and artificial intelligence.

For example, it is possible to calculate the degree of reduction in the number of grooves of the tire with reference to grooves of a new tire. For example, when about half the number of grooves is reduced with reference to the number of grooves of a new tire, 50% is calculated as the degree of reduction in the number of grooves of the tire. This calculation method is a method of calculating the degree of reduction in the number of grooves of the tire for changing the display mode of the character D1, and does not determine a replacement period of the grooves of the tire in detail. In this example, the degree of reduction in the number of grooves of the tire is 0 in the case of a new tire, and the degree of reduction in the number of grooves of the tire is 100% in the case of exceeding a replacement reference as a standard.

For example, when the degree of reduction in the number of grooves of the tire exceeds a predetermined value, for example, 50% to 60%, the tire with reduced grooves is detected. When the tire with reduced grooves is detected, the process proceeds to step S542. On the other hand, when the tire with reduced grooves is not detected, the operation of the tire groove determination processing is ended.

In step S542, the deterioration degree determination unit 105 sets a groove evaluation value according to the degree of reduction in the number of grooves of the tire detected in step S541. For example, a value of the degree of reduction in the number of grooves of the tire calculated in step S541 can be set as the groove evaluation value. For example, when 58% is calculated as the degree of reduction in the number of grooves of the tire in step S541, “58” is stored in the tire groove 127 (see FIG. 4) of the evaluation value DB 120.

In this manner, when the groove evaluation value is increased, a performance is performed such that an action expression when the character D1 moves becomes gradually stilted according to the increase in the groove evaluation value. For example, the character D1 can be moved terribly frustrated or slowly moved. For example, it is possible to perform a performance that makes an expression of being difficult to walk when the character D1 moves, as illustrated in (B) and (C) of FIG. 7.

### Operation Example of Tire Air Pressure Determination Processing

FIG. 14 is a flowchart illustrating an example of tire air pressure determination processing in the information processing device 100. The tire air pressure determination processing is performed based on a program stored in the storage unit 107. The tire air pressure determination processing is always performed in each control cycle. The tire air pressure determination processing will be described with reference to FIGS. 1 to 13 as appropriate.

In step S551, the deterioration degree determination unit 105 determines whether a tire having an air pressure out of a predetermined range is detected. Specifically, the deterioration degree determination unit 105 detects a tire having an air pressure out of a predetermined range based on the information from the external signal input unit 11, the exterior camera 16, the component state determination unit 101, the elapsed time determination unit 102, and the travel distance determination unit 103.

For example, it is possible to detect a tire having an air pressure out of a predetermined range using the elapsed time or the travel distance, similarly to FIGS. 9 and 10. When information related to the tire is input to the external signal input unit 11 by a user operation, transmission from an external device, or the like, the deterioration degree determination unit 105 may detect a tire having an air pressure out of a predetermined range based on the input information. When the state of the tire may be determined by each sensor related to the tire, the deterioration degree determination unit 105 may detect a tire having an air pressure out of a predetermined range based on the information from the component state determination unit 101. For example, the air pressure of the tire may be detected using the air pressure sensor 12 that detects the air pressure of the tire.

A tire having an air pressure out of a predetermined range may be determined using the exterior camera 16 which is capable of acquiring a captured image of the tire. For example, a captured image of the tire immediately after introduction of air is acquired by the exterior camera 16 and stored in the storage unit 107. Then, captured images of the tire are sequentially acquired by the exterior camera 16, and the acquired captured images are compared with the captured image stored in the storage unit 107. The tire having an air pressure out of a predetermined range may be detected based on whether a difference value between the captured image of the tire immediately after introduction of air and the captured image acquired thereafter is equal to or greater than a predetermined value based on a comparison result. For example, the tire having an air pressure out of a predetermined range may be detected by performing prediction processing such as prediction of the air pressure of the tire using the captured image and artificial intelligence.

For example, a degree of the air pressure of the tire may be calculated based on a preset appropriate range of the air pressure. For example, when the appropriate range of the air pressure is used as a reference and the air pressure of the tire is out of the appropriate range, a difference value from the appropriate range is calculated as the degree of the air pressure of the tire. This calculation method is a method of calculating the degree of the air pressure of the tire for changing the display mode of the character D1, and does not determine a replenishment period of the air in the tire in detail. In this example, the degree of the air pressure of the tire is 0 in the case of a tire within the appropriate range, and the degree of the air pressure of the tire is a value larger than 0 in the case of a tire having an air pressure out of the appropriate range.

For example, when the degree of the air pressure of the tire exceeds a predetermined value, for example, 50% to 60%, a tire whose air pressure is out of a predetermined range is detected. When a tire whose air pressure is out of the predetermined range is detected, the process proceeds to step S552. On the other hand, when a tire whose air pressure is out of the predetermined range is not detected, the operation of the tire air pressure determination processing is ended.

In step S552, the deterioration degree determination unit 105 sets an air pressure evaluation value according to the degree of the air pressure of the tire detected in step S551. For example, a value of the degree of the air pressure of the tire calculated in step S551 can be set as the air pressure evaluation value. For example, when 51% is calculated as the degree of the air pressure of the tire in step S551, “51” is stored in the tire air pressure 128 (see FIG. 4) of the evaluation value DB 120.

In this manner, when the air pressure evaluation value is increased, a performance is performed such that an action expression when the character D1 moves becomes gradually stilted according to the increase in the air pressure evaluation value. For example, the character D1 can be moved terribly frustrated or slowly moved. For example, it is possible to perform a performance that makes an expression of being difficult to walk when the character D1 moves, as illustrated in (B) and (C) of FIG. 7.

### Operation Example of Maintenance Execution Determination Processing

Next, an operation of determination processing for determining execution of maintenance of the vehicle C1 will be described.

FIG. 15 is a flowchart illustrating an example of maintenance execution determination processing in the information processing device 100. The maintenance execution determination processing is performed based on a program stored in the storage unit 107. The maintenance execution determination processing is always performed in each control cycle. The maintenance execution determination processing will be described with reference to FIGS. 1 to 14 as appropriate.

In step S601, the execution determination unit 106 determines whether maintenance of the vehicle C1 is executed. Specifically, the execution determination unit 106 determines whether the maintenance of the vehicle C1 is executed based on the information from the external signal input unit 11, the exterior camera 16, the interior camera 17, the position information acquisition sensor 18, the component state determination unit 101, the elapsed time determination unit 102, and the travel distance determination unit 103.

### Determination Example for Determining Execution of Maintenance

Here, a determination method for determining that the maintenance of the vehicle C1 is executed will be described. The maintenance of the vehicle C1 is, for example, replacement of a component of the vehicle C1, replenishment of a component of the vehicle C1, cleaning of the vehicle C1, or inspection of the vehicle C1.

### Determination Example for Determining Replacement and Replenishment of Component of Vehicle C1

When information related to replacement or replenishment of a component is input to the external signal input unit 11 by a user operation, transmission from an external device, or the like, the execution determination unit 106 can determine that replacement or replenishment of a component is executed based on the input information. For example, when replacement or replenishment of a component is executed at a dealer of the vehicle C1, predetermined information related to the replaced or replenished component, for example, a completion code is input to the external signal input unit 11 after execution of the replacement or replenishment. It is possible to determine replacement or replenishment of a component based on the completion code.

When the state of the component may be determined by each sensor related to the component, the execution determination unit 106 may detect that the replacement or replenishment of the component is executed based on the information from the component state determination unit 101, For example, it is possible to detect that the air of the tire is replenished using the air pressure sensor 12 that detects the air pressure of the tire.

The execution of the replacement or replenishment of a component may also be determined using the exterior camera 16 or the interior camera 17. For example, a captured image of a component immediately after replacement or replenishment is acquired by the exterior camera 16 or the interior camera 17 and stored in the storage unit 107. Then, captured images of the component are sequentially acquired by the exterior camera 16 or the interior camera 17, and the acquired captured images are compared with the captured image stored in the storage unit 107. The replacement or replenishment of the component may be detected based on whether a difference value between the captured image of the component immediately after the replacement or replenishment and a captured image acquired thereafter is less than a predetermined value based on a comparison result. For example, the execution of the replacement or replenishment of a component may be detected by performing prediction processing such as execution prediction of replacement or replenishment of a component using the captured image and artificial intelligence.

In addition to the above determination processing, determination processing using the position information acquired from the position information acquisition sensor 18 may be performed. For example, the execution of the replacement or replenishment of a component may be detected, based on the position information acquired from the position information acquisition sensor 18, on conditions that the vehicle C1 is present in a dealer of the vehicle C1 or a maintenance factory of the vehicle and it is determined that the replacement or replenishment of a component is executed by the determination processing using the exterior camera 16 or the interior camera 17 and the component state determination unit 101.

### Determination Example for Determining Cleaning of Vehicle C1

When information related to cleaning of the vehicle C1 is input to the external signal input unit 11 by a user operation, transmission from an external device, or the like, the execution determination unit 106 can determine that the cleaning of the vehicle C1 is executed based on the input information. When the state of the body or the interior of the vehicle C1 may be determined by each sensor related to the body or the interior of the vehicle C1, the execution determination unit 106 may detect that the cleaning of the vehicle C1 is executed based on information from the component state determination unit 101.

The execution of the cleaning of the vehicle C1 may be determined using the exterior camera 16 or the interior camera 17. For example, a captured image of the body or the interior of the vehicle C1 immediately after the cleaning of the vehicle C1 is acquired by the exterior camera 16 or the interior camera 17 and stored in the storage unit 107. Then, captured images of the body or the interior of the vehicle C1 are sequentially acquired by the exterior camera 16 or the interior camera 17, and the acquired captured images are compared with the captured image stored in the storage unit 107. The execution of the cleaning of the vehicle C1 may be detected based on whether a difference value between the captured image of the body or the interior of the vehicle C1 immediately after the execution of the cleaning of the vehicle C1 and a captured image acquired thereafter is less than a predetermined value based on a comparison result. For example, the execution of the cleaning of the vehicle C1 may be detected by performing prediction processing such as prediction of the execution of the cleaning of the vehicle C1 using the captured image and artificial intelligence.

In addition to the above determination processing, determination processing using the position information acquired from the position information acquisition sensor 18 may be performed. For example, the execution of the cleaning of the vehicle C1 may be detected, based on the position information acquired from the position information acquisition sensor 18, on conditions that the vehicle C1 is present in a dealer of the vehicle C1, a vehicle maintenance factory, or a car wash, and it is determined that the cleaning of the vehicle C1 is executed by the determination processing using the exterior camera 16 or the interior camera 17 and the component state determination unit 101. For example, the execution of the cleaning of the vehicle C1 may be detected, based on the position information acquired from the position information acquisition sensor 18, when it is detected that the vehicle C1 stays in the car wash for a predetermined time.

### Determination Example for Determining Inspection of Vehicle C1

When information related to inspection of the vehicle C1 is input to the external signal input unit 11 by a user operation, transmission from an external device, or the like, the execution determination unit 106 can determine that the inspection of the vehicle C1 is executed based on the input information.

In addition to the above determination processing, determination processing using the position information acquired from the position information acquisition sensor 18 may be performed. For example, the execution of the inspection of the vehicle C1 may be determined, based on the position information acquired from the position information acquisition sensor 18, on conditions that the vehicle C1 is present in a dealer of the vehicle C1, a vehicle maintenance factory, or a gasoline stand and it is determined that the inspection of the vehicle C1 is executed by the above determination processing.

When the maintenance of the vehicle C1 is executed, the process proceeds to step S602. On the other hand, when the maintenance of the vehicle C1 is not executed, the operation of the maintenance execution determination processing is ended.

In step S602, the execution determination unit 106 determines whether the maintenance of the vehicle C1 is executed in a specific facility. Specifically, the execution determination unit 106 determines whether the maintenance of the vehicle C1 is executed in a specific facility based on the from the external signal input unit 11, the exterior camera 16, and the position information acquisition sensor 18. Here, the specific facility is a preset facility, and refers to a facility in which the maintenance of the vehicle C1 may be executed. The specific facility may be, for example, an authorized dealer of the vehicle C1.

For example, when information related to execution of the maintenance is input to the external signal input unit 11 by a user operation, transmission from an external device, or the like, the execution determination unit 106 can determine whether the maintenance is executed in a specific facility based on the input information. As described above, for example, when replacement or replenishment of a component is executed at an authorized dealer of the vehicle C1, predetermined information related to the replaced or replenished component, for example, a completion code is input to the external signal input unit 11 after the replacement or replenishment is executed. It is possible to specify an authorized dealer together with replacement or replenishment of a component based on the completion code.

In addition, whether the maintenance of the vehicle C1 is executed in a specific facility may be determined based on the position information acquired from the position information acquisition sensor 18. For example, when it is determined that a place where the execution of the maintenance of the vehicle C1 is determined is an authorized dealer of the vehicle C1 based on the position information acquired from the position information acquisition sensor 18, it can be determined that the maintenance of the vehicle C1 is executed at a specific facility.

When the maintenance of the vehicle C1 is executed in a specific facility, the process proceeds to step S603. On the other hand, when the maintenance of the vehicle C1 is not executed in a specific facility, the process proceeds to step S604.

In step S603, the execution determination unit 106 changes an evaluation value to be subjected to the maintenance determined to be executed in step S601, and records the execution in a specific facility in the storage unit 107. For example, when a component C (corresponding to component C 123 illustrated in FIG. 4) is replaced in a specific facility, the component C 123 of the evaluation value DB 120 is “0”.

The execution determination unit 106 stores, in the maintenance information DB 130, an execution time, an execution place, contents, and the like of the maintenance determined to be executed in step S601 (see FIG. 5). For example, information such as the date and time 131, the position information 132, the facility information 133, the maintenance content 134, and the maintenance portion 135 is stored. In this case, information indicating a specific facility is stored in the facility information 133.

In step S604, the execution determination unit 106 changes the evaluation value to be subjected to the maintenance determined to be executed in step S601. For example, when the wiper is replaced at home, the wiper deterioration 126 of the evaluation value DB 120 is “0”.

In addition, the execution determination unit 106 stores, in the maintenance information DB 130, an execution time, an execution place, contents, and the like of the maintenance determined to be executed in step S601.

### Operation Example of Character Output Processing

Next, an operation of output processing of outputting the character D1 from the information output device 200 will be described.

FIG. 16 is a flowchart illustrating an example of character output processing in the information processing device 100. The character output processing is performed based on a program stored in the storage unit 107. The character output processing is always performed in each control cycle. The character output processing will be described with reference to FIGS. 1 to 15 as appropriate.

In step S701, the output control unit 109 determines whether an output timing of the character D1 is reached. The output timing of the character D1 may be, for example, a timing at which a user operation for displaying the character D1 is performed, a timing at which maintenance of the vehicle C1 is executed, a timing at which the content of the evaluation value DB 120 is changed, a timing at which the deterioration degree of the vehicle C1 deteriorates, or a periodic timing. This is merely an example, and the character D1 may be displayed at another timing.

In step S702, the determination unit 108 determines whether the maintenance of the vehicle C1 is being executed. An execution determination method of the maintenance of the vehicle C1 may be the same as the method illustrated in FIG. 15. As described above, in the present embodiment, a period until a predetermined time elapses after the execution of the maintenance is determined is described as a period during which the maintenance is being executed. When the maintenance of the vehicle C1 is being executed, the process proceeds to step S703. On the other hand, when the maintenance of the vehicle C1 is not being executed, the process proceeds to step S704.

In step S703, the determination unit 108 determines the appearance, the operation, and the performance of the character D1 based on the executed maintenance and the evaluation value DB 120. As described above, after the determination of the execution of the maintenance, the display mode of the character D1 is transitioned in the order of the deterioration display mode→the transition performance mode (omissible)→the post-maintenance display mode→the reference display mode. While it is determined that the maintenance is being executed, that is, in step S703, the display mode of the character D1 is transitioned in the order of the transition performance mode and the post-maintenance display mode. When it is not determined that the maintenance is being executed, the display mode of the character D1 is transitioned from the post-maintenance display mode to the reference display mode.

For example, as illustrated in (D) and (E) of FIG. 6, (D) and (E) of FIG. 7, and (D) and (E) of FIG. 8, the appearance, the operation, and the performance of the character D1 can be determined based on the executed maintenance. For example, as illustrated in (D) of FIG. 6, when the executed maintenance is washing, the performance PF2 in which the character D1 is showering is determined as the transition performance mode. In this case, the shower and the bath are determined as the background image of the character D1. Similarly, for example, when the executed maintenance is washing, the performance PF2 in which the contaminated character D1 gradually becomes clean while showering is determined as the transition performance mode. The sound information S4 related to the performance is determined. For example, as illustrated in (D) of FIG. 8, when the executed maintenance is wiper replacement, the performance PF23 in which the wiper moves in front of the blurred character D1 is determined as the transition performance mode. The performance PF23 in which the blurred character D1 gradually becomes clear according to the movement of the wiper is determined as the transition performance mode. The sound information S24 related to the performance is determined.

The appearance, the operation, and the performance of the character D1 may be determined based on the place where the maintenance is executed. For example, different performances can be performed according to a case where the place where the maintenance is executed is a specific facility and a case where the place where the maintenance is executed is a place other than the specific facility. For example, when the maintenance is being executed in a specific facility, a performance representing that the dog of the character D1 is extremely refreshed and clean is performed. On the other hand, when the maintenance is being executed at a place other than the specific facility, a performance representing that the dog of the character D1 is refreshed and clean to some extent is performed.

For example, the post-maintenance display mode is determined in which it is performed that the dog of the character D1 is refreshed when the executed maintenance is replacement or replenishment of a component. In addition, the post-maintenance display mode is determined in which it is performed that the dog of the character D1 sparkles when the executed maintenance is cleaning of the vehicle C1. In addition, the post-maintenance display mode is determined in which it is performed that the dog of the character D1 is joyful when the executed maintenance is inspection.

In step S704, the determination unit 108 determines the appearance, the operation, and the performance of the character D1 based on the evaluation value DB 120. For example, when each evaluation value in the evaluation value DB 120 is “0”, the character D1 in the reference display mode is determined as the appearance of the character D1, as illustrated in (A) of FIG. 6 and the like. For example, when the vehicle contamination 124 of the evaluation value DB 120 is a value of about “50” to “80” and other evaluation values are “0”, the character D1 of a contaminated dog is determined as the appearance of the character D1, and a plodding operation is determined as the operation of the character D1, as illustrated in (B) and (C) of FIG. 6 and the like. Similarly, for example, when the vehicle contamination 124 of the evaluation value DB 120 is a value of about “50” to “80” and other evaluation values are “0”, the performance PF1 or the like with vertical lines indicating the expression of the grief or the like is determined as the performance of the character D1, as illustrated in (B) and (C) of FIG. 6 and the like. Sound information related to the performances is determined. In steps S703 and S704, an example in which the appearance, the operation, and the performance of the character D1 are determined using the evaluation value DB 120 is illustrated, but the appearance, the operation, and the performance of the character D1 may be determined directly using a determination result of the deterioration degree determination unit 105 without providing the evaluation value DB 120.

Here, when there are a plurality of predetermined values, for example, 50 or more evaluation values among the evaluation values of the evaluation value DB 120, the appearance, the operation, and the performance of the character D1 are determined based on the plurality of evaluation values. For example, it is assumed that the evaluation values of the vehicle contamination 124 and the wiper deterioration 126 are 50 or more and other evaluation values are close to 0. In this case, it is possible to set a display mode in which the appearance, the operation, and the performance of the character D1 illustrated in (C) of FIG. 6 can be combined with the appearance, the operation, and the performance of the character D1 illustrated in (C) of FIG. 8. That is, the appearance, the operation, and the performance of the dog such that the display screen is blurred are determined in addition to the appearance, the operation, and the performance of the contaminated dog. In this manner, regarding a plurality of display modes that may be executed simultaneously, the display modes may be executed in combination with one another.

A plurality of display modes that may not be executed simultaneously are also assumed. Thus, a priority may be set for the display modes, and the display mode of the character D1 may be determined based on the priority. For example, the display mode of the character D1 can be determined based on a predetermined number of items having high values, for example, about 2 and 3 items, among the evaluation values of the evaluation value DB 120. For example, when the evaluation values illustrated in FIG. 4 are set, the display mode of the character D1 can be determined based on two items having high values, that is, the wiper deterioration 126 (87) and the component B 122 (71).

A unique priority may be set for the display modes, and the display mode of the character D1 may be determined based on the priority. For example, among the items of the evaluation value DB 120, priority 1 is set for the component A 121, priority 2 is set for the component B 122, and priority 3 is set for the component C 123, and thereafter the priority is set in the same manner. Then, when there are a plurality of predetermined values, for example, 50 or more evaluation values, among the evaluation values of the evaluation value DB 120, the appearance, the operation, and the performance of the character D1 are determined based on a predetermined number of evaluation values having a high priority. When there are a plurality of predetermined values, for example, 50 or more evaluation values among the evaluation values of the evaluation value DB 120, the display mode of the character D1 based on each evaluation value may be sequentially determined and performed in a predetermined order. Each time the evaluation value of the evaluation value DB 120 is changed, the display mode of the character D1 based on the changed evaluation value may be sequentially performed. Each time the maintenance is executed, the display modes of the character D1 based on the maintenance may be sequentially performed.

Regarding sound output modes, a plurality of sound output modes can be executed in combination with one another using a priority in the same manner.

In step S705, the output control unit 109 performs character output processing based on the determination content in step S703 or S704.

In step S706, the output control unit 109 determines whether an end timing of the output of the character D1 is reached. The end timing may be, for example, a timing at which a user operation for ending the output of the character D1 is performed, a timing at which a predetermined time elapses after the output of the character D1 is started, a timing at which a predetermined time elapses after the maintenance of the vehicle C1 is executed, or a periodic timing. This is an example, and the output of the character D1 may be ended at another timing. When the end timing of the output of the character D1 is reached, the operation of the character output processing is ended. On the other hand, when the end timing of the output of the character D1 is not reached, the process proceeds to step S707.

In step S707, the determination unit 108 determines whether the content of the evaluation value DB 120 is changed. When the content of the evaluation value DB 120 is changed, the process returns to step S702. On the other hand, when the content of the evaluation value DB 120 is not changed, the process proceeds to step S708.

In step S708, the output control unit 109 continues to perform the output processing of the character D1. For example, when output processing in a display mode in which the dog of the character D1 is walking is performed, the walking operation is continuously performed. For example, when output processing in a display mode in which the dog of the character D1 is doing something is performed, the operation is continuously performed.

### Example in which Output Processing of Character is Performed by Plurality of Devices

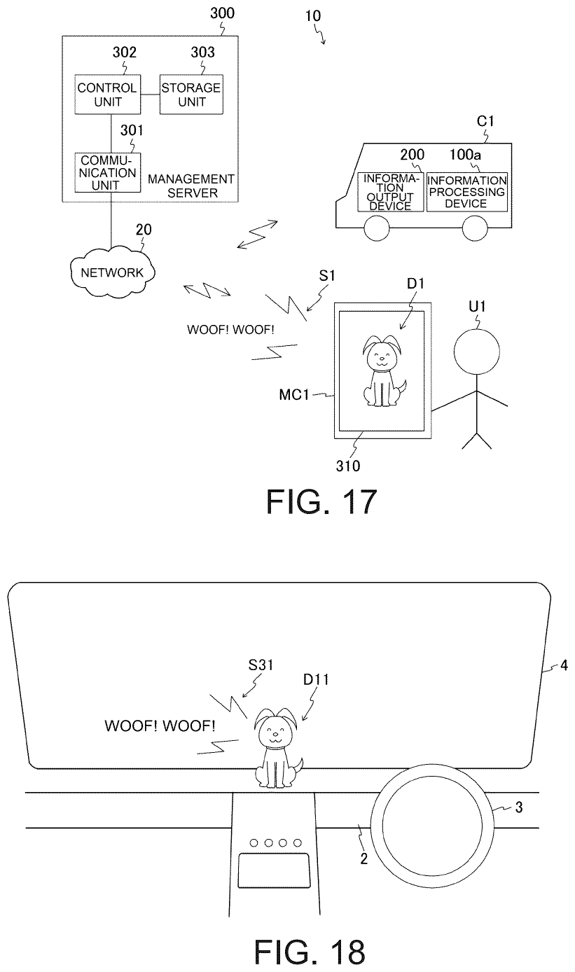

Although an example in which output processing is performed in the information processing device 100 is described above, all or part of the output processing may be executed in another device. Although an example in which display and sound output of the character D1 are performed in the information output device 200 is described, the display and the sound output of the character D1 may be performed in another device. Thus, FIG. 17 illustrates an example in which display processing and sound output processing of the character D1 are performed using a device other than the information processing device 100 and the information output device 200.

### Configuration Example of Information Processing System

FIG. 17 is a block diagram illustrating an example of a system configuration of the information processing system 10.

The information processing system 10 is a communication system for performing display processing and sound output processing of the character D1, and is configured such that a management server 300 and another device may communicate with each other via a network 20. For example, the management server 300, an information processing device 100a, and an electronic device MC1 are configured to be communicable via the network 20.

The electronic device MC1 is a communication device carried by an owner U1 of the vehicle C1, and is a wireless device connectable to the network 20 using wireless communication. The electronic device MC1 is a communicable information processing device such as a smartphone, a tablet device, or a movable personal computer. A communication function may be incorporated in the electronic device MC1 or may be used as an external device attached to the electronic device MC1.

Although only one vehicle C1 is illustrated in FIG. 17 for ease of description, the present embodiment is also applicable to a case where there are a plurality of vehicles. Although FIG. 17 illustrates an example in which one electronic device MC1 is used in one vehicle C1 for ease of description, the present embodiment is also applicable to a case where a plurality of electronic devices are used in one vehicle C1.

The network 20 is a network such as a public line network or the Internet. Each device constituting the information processing system 10 is connected to the network 20 by either a communication method using wireless communication or a communication method using wired communication, or by both methods.

The information processing device 100a is obtained by partially modifying the information processing device 100 illustrated in FIG. 3, and includes a communication unit that transmits information related to the vehicle C1 to the management server 300 using wireless communication. For example, information from the external signal input unit 11, the exterior camera 16, the interior camera 17, the position information acquisition sensor 18, the component state determination unit 101, the elapsed time determination unit 102, and the travel distance determination unit 103 is transmitted to the management server 300.

The management server 300 includes a communication unit 301, a control unit 302, and a storage unit 303. For example, in a case where information transmitted from the information processing device 100a is received, the management server 300 can be a server that stores and manages the information in the storage unit 303 and provides a content in response to a request from the electronic device MC1. The content is, for example, the character D1 and the sound information illustrated in FIGS. 6 to 8.

The communication unit 301 exchanges various types of information with another device by using wired communication or wireless communication under control of the control unit 302.

The control unit 302 controls the units based on various programs stored in the storage unit 303. The control unit 302 is implemented by a processing device such as a CPU. The control unit 302 includes, as a functional configuration, processing units corresponding to the situation determination unit 104, the determination unit 108, and the output control unit 109 illustrated in FIG. 3. The processing unit corresponding to the output control unit 109 performs control for outputting a content from the electronic device MC1, for example, for display and sound output, based on information from the situation determination unit 104 and the determination unit 108.

The storage unit 303 is a storage medium that stores various types of information. For example, the storage unit 303 stores various types of information (for example, control program, evaluation value DB 120 (see FIG. 4), maintenance information DB 130 (see FIG. 5), and character information DB 140 (see FIG. 3)) necessary for the control unit 302 to perform various types of processing. As the storage unit 303, for example, a ROM, a RAM, an HDD, an SSD, or a combination thereof can be used. The evaluation value DB 120 and the maintenance information DB 130 store information transmitted from the information processing device 100a for each vehicle.

For example, all of the character output processing may be performed in the management server 300. A part of the character output processing may be performed in the management server 300, or other character output processing may be performed in another device, for example, the information processing device 100a. In this case, the information processing system is configured by each device that executes a part of the character output processing.

FIG. 3 illustrates an example in which the evaluation value DB 120 (see FIG. 4), the maintenance information DB 130 (see FIG. 5), and the character information DB 140 (see FIG. 3) are managed in the information processing device 100. FIG. 17 illustrates an example in which the evaluation value DB 120 (see FIG. 4), the maintenance information DB 130 (see FIG. 5), and the character information DB 140 (see FIG. 3) are managed in the management server 300. However, the respective DBs may be managed by one or a plurality of devices other than the information processing devices 100 and 100a and the management server 300, and the information processing devices 100 and 100a or the management server 300 may acquire information of the respective DBs managed by the other devices and use the information for the character output processing.

A part (or all) of the information processing system capable of performing the functions of the information processing devices 100 and 100a or the management server 300 may be provided by an application that may be provided via a predetermined network such as the Internet. This application is, for example, software as a service (Saas).

### Example of Using Character Device

Although an example in which the character D1 is displayed on the display unit 201 of the information output device 200 and the display unit 310 of the electronic device MC1 is described above, a small-sized robot may be used as the character. Thus, FIG. 18 illustrates an example in which character output processing is performed using a character device D11.

FIG. 18 is a diagram illustrating a simplified configuration example of the interior of the cabin of the vehicle C1. The example illustrated in FIG. 18 is a modification of FIG. 2, and is different in that the character device D11 is installed instead of the information output device 200. Since the other points are the same as those in FIG. 2, detailed description other than the character device D11 is omitted. In the example illustrated in FIG. 18, it is assumed that a control device corresponding to the information processing device 100 (see FIG. 3) controls the character device D11.

The character device D11 is a small-sized robot installed on the dashboard 2 of the vehicle C1. FIG. 18 illustrates an example in which a robot imitating an animal such as a dog is the character device D11. Although FIG. 18 illustrates an example in which the character device D11 is installed on the dashboard 2, the present disclosure is not limited thereto. For example, the character device D11 may be installed at an upper portion of the windshield 4, or the character device D11 may be installed at a front side of a rear seat. Although FIG. 18 illustrates an example in which a robot imitating an animal such as a dog is the character device D11, the present disclosure is not limited thereto. For example, a robot imitating another animal, a robot imitating an organism of a virtual object (for example, face of animation character), or a robot imitating another object (for example, television device or radio device) may be set as the character device D11.

The character device D11 performs various operations based on instructions from the control device corresponding to the information processing device 100. For example, an operation mode of the character device D11 is changed, so that it is possible to add a change to an appearance of the character device D11 and visually grasp the change. For example, it is possible to change sound output from the character device D11, an expression of a face of the character device D11, a color of the face, and an operation of the face. For example, the expression of the face, the movement of the body, and the like can be changed by changing each part (for example, eye part, mouth part, hand part, and body part) on a surface of the character device D11.

For example, the character device D11 outputs sound information based on control of the control device corresponding to the information processing device 100.

In this manner, in the present embodiment, when the maintenance of the vehicle C1 is not executed, a display mode of the character D1 that is negatively affected, that is, the deterioration display mode is set. For example, it is possible to set a deterioration display mode in which the character D1 is contaminated in a case where traveling continues without exchanging oil. In addition, for example, it is possible to set a deterioration display mode in which the character D1 runs a fever immediately in a case where traveling continues without exchanging cooling water. In addition, for example, it is possible to set a deterioration display mode in which the display screen of the character D1 is blurred in a case where the wiper is not changed. In addition, for example, it is possible to set a deterioration display mode in which the character D1 is moved terribly frustrated in a case where the air pressure of the tire decreases.

In addition, it is possible to set a deterioration display mode in which the appearance of the character D1 is contaminated when engine oil and an oil filter are deteriorated. In addition, it is possible to set a deterioration display mode in which the movement of the character D1 is dull when the battery is deteriorated. In addition, it is possible to set a deterioration display mode in which the character D1 coughs when an air conditioner filter is deteriorated. In addition, it is possible to set a deterioration display mode in which the character D1 is contaminated or easily rolls when brake oil is deteriorated.

In this manner, grief among joy, anger, grief, and pleasure is expressed by the character D1 when the deterioration degree of the component of the vehicle C1 deteriorates, or when the contamination degree of the vehicle C1 deteriorates. For example, it is possible to cause the character to be tired and grief, cry, slouch, or in a state of fatigue. That is, a performance is performed such that the sense of grief is expressed not only on the component or the appearance of the vehicle C1, but also on the character D1. Accordingly, it is possible to enhance the sense of intimacy to the character D1 and to enhance the attachment to the vehicle C1.

In the present embodiment, a display mode of the character D1 that is positively affected, that is, the post-maintenance display mode is set after the maintenance of the vehicle C1 is executed. For example, it is possible to set a post-maintenance display mode in which the character D1 sparkles, or a post-maintenance display mode in which the character D1 is refreshed. That is, when the maintenance of the vehicle C1 is executed, joy or pleasure among joy, anger, grief, and pleasure is expressed by the character D1.

In the present embodiment, the character D1 in the performance display mode is displayed during transition from the deterioration display mode to the post-maintenance display mode. Accordingly, the user can feel a. change in the character D1 when the emotion of the character D1 is switched from grief to joy. Accordingly, it is possible to further enhance the sense of intimacy to the character D1 and to further enhance the attachment to the vehicle C1.

For example, it is assumed that when oil exchange is performed in response to warning light display of the vehicle C1, the user often feels that the oil exchange is performed since an instruction is given, and the user hardly feels that the vehicle C1 is taken care. It is assumed that in this case, it is difficult to increase the awareness of the user to actively manage the vehicle C1 without feeling the attachment to the vehicle C1. In addition, a delay in maintenance of the vehicle C1 may occur in a case where the initiative to manage the vehicle C1 cannot be enhanced.

On the other hand, in the present embodiment, it is possible to give a sense of intimacy or attachment to the character D1 by giving a sense of taking care of the character D1 according to the execution of the maintenance of the vehicle C1. Accordingly, it is possible to give a sense of intimacy and attachment to the vehicle C1 related to the character D1. For example, the user can feel attachment to the character D1 and the vehicle C1 by taking care of the vehicle C1, similar to the user feels attachment to a pet cared by himself or herself. In this manner, it is possible to enhance the attachment to the vehicle C1 and to enhance the initiative to actively manage the vehicle C1. Accordingly, it is possible to prevent a delay in maintenance on the vehicle C1. In addition, it is possible to increase the number of users who use a specific facility by performing different performances depending on the facility where the maintenance is executed.

### Configuration and Effects of Present Embodiment

A control method for the information processing device 100 according to the present embodiment (including control method for management server 300 and control method for control device corresponding to information processing device 100 that changes mode of character device D11, and the same applies hereinafter) is a control method for an information processing device that changes a mode of the character D1. This control method includes determination processing of determining whether maintenance of the vehicle C1 is executed (steps S601 and S702), and control processing of changing at least one of an appearance or an operation of the character D1 based on execution of the maintenance (steps S703 and S705).

With this configuration, a user who views the change of the character D1 after the maintenance is executed can enhance the sense of intimacy to the character D1 and can enhance the attachment to the vehicle C1. Since the user can view the change of the character D1 every time the maintenance is executed, it is possible to increase the initiative to actively manage the vehicle C1 and to increase the execution frequency of the maintenance on the vehicle C1. Accordingly, it is possible to prevent a delay in maintenance on the vehicle C1.

The display control method according to the present embodiment further includes determination processing (steps S501, S511, S521, S531, S541, and S551) of determining a deterioration degree of the vehicle C1, and in the control processing (steps S702 to S705), at least one of the appearance or the operation of the character D1 is changed, based on the deterioration degree, in a deterioration mode different from the change based on the execution of the maintenance.

With this configuration, the character D1 is changed in a deterioration mode according to a deterioration degree of a component of the vehicle C1 or a contamination degree of the vehicle C1, for example, in a mode of expressing grief among joy, anger, grief, and pleasure, so that the character D1 may express the grief. Accordingly, it is possible to enhance the sense of intimacy to the character D1 and to enhance the attachment to the vehicle C1.

In the display control method according to the present embodiment, the deterioration degree of the vehicle C1 is at least one of the deterioration degree of the component of the vehicle C1 or a contamination degree of an appearance of the vehicle C1, and in the control processing (steps S702 to S705), a mode in which a deterioration state of the vehicle C1 assumed to occur based on the deterioration degree of the vehicle C1 is reflected in the character D1 is set as the deterioration mode.

With this configuration, since the deterioration state of the vehicle C1 can be reflected in the character D1, the user can easily grasp the deterioration state of the vehicle C1 by viewing the character D1.

In the display control method according to the present embodiment, the character D1 is a character of a pseudo-biological dog capable of expressing emotions of joy, anger, grief, and pleasure, and in the control processing (steps S702 to S705), a mode in which when the deterioration degree of the vehicle C1 deteriorates, the emotion of grief of the character D1 increases according to the deterioration is set as the deterioration mode.

With this configuration, the character D1 is changed in a mode in which the emotion of grief is increased when the deterioration degree of the component of the vehicle C1 deteriorates, or when the contamination degree of the vehicle C1 deteriorates, so that it is possible to further cause the character D1 to express the emotion of grief. Accordingly, it is possible to enhance the sense of intimacy to the character D1 and to enhance the attachment to the vehicle C1.

In the display control method according to the present embodiment, in the control processing (steps S702 to S705), a mode in which when the deterioration degree of the vehicle C1 deteriorates, the character D1 is contaminated according to the deterioration is set as the deterioration mode.

With this configuration, the character D1 is changed in a mode in which the character D1 is contaminated when the deterioration degree of the component of the vehicle C1 deteriorates, or when the contamination degree of the vehicle C1 deteriorates, so that it is possible to further cause the character D1 to express the emotion of grief. Accordingly, it is possible to enhance the sense of intimacy to the character D1 and to enhance the attachment to the vehicle C1.

In the display control method according to the present embodiment, in the control processing (steps S702 to S705), blur processing is performed in which when the deterioration degree of the vehicle C1 deteriorates, at least a part of the appearance of the character D1 is blurred according to the deterioration.

With this configuration, the character D1 is changed in a mode in which the character D1 is blurred when the deterioration degree of the component of the vehicle C1 deteriorates, or when the contamination degree of the vehicle C1 deteriorates, so that it is possible to further cause the character D1 to express the emotion of grief. Accordingly, it is possible to enhance the sense of intimacy to the character D1 and to enhance the attachment to the vehicle C1.

In the display control method according to the present embodiment, the character D1 is a character of a pseudo-biological dog that can move, and in the control processing (steps S702 to S705), a mode in which when the deterioration degree of the vehicle C1 deteriorates, a movement speed of the character D1 decreases or a movement amount of the character D1 decreases according to the deterioration is set as the deterioration mode.

With this configuration, the character D1 is changed in a mode in which the character D1 slowly moves when the deterioration degree of the component of the vehicle C1 deteriorates, or when the contamination degree of the vehicle C1 deteriorates, so that it is possible to further cause the character D1 to express the emotion of grief. Accordingly, it is possible to enhance the sense of intimacy to the character D1 and to enhance the attachment to the vehicle C1.

In the display control method according to the present embodiment, the character D1 is a character having a reference mode as a reference, execution of the maintenance is at least one of replacement of a component of the vehicle C1, replenishment of a component of the vehicle C1, cleaning of the vehicle C1, or inspection of the vehicle C1, and in the control processing (steps S702, S703, and S705), the character D1 is changed from the deterioration mode to the reference mode after the maintenance is executed. For example, the character D1 (example of deterioration mode) in the deterioration display mode illustrated in (B) and (C) of FIG. 6 can be changed to the character D1 (example of reference mode) in the reference display mode illustrated in (A) of FIG. 6.

With this configuration, the user who views the character D1 returning from a grief mode to a normal mode after the maintenance is executed can enhance the sense of intimacy to the character D1, and can enhance the attachment to the vehicle C1. Since the grief mode of the character D1 is returned to the normal mode, the user can increase the initiative to actively manage the vehicle C1, and can increase the execution frequency of the maintenance on the vehicle C1.

In the display control method according to the present embodiment, in the control processing (steps S702, S703, and S705), at least one of the appearance or the operation of the character D1 is changed when the maintenance is executed, so as to reflect, in the character D1, a mode related to the state of the vehicle C1 assumed to occur based on the execution of the maintenance.

With this configuration, since a mode related to the executed maintenance can be reflected in the character D1, the user who views the character D1 can enhance the sense of intimacy to the character D1, and can enhance the attachment to the vehicle C1. Since the user can view the change of the character D1 every time the maintenance is executed, it is possible to increase the initiative to actively manage the vehicle C1 and to increase the execution frequency of the maintenance on the vehicle C1.

In the display control method according to the present embodiment, in the control processing (steps S702, S703, and S705), a performance using the character D1 after the maintenance changed based on the execution of the maintenance is performed. For example, the performance as illustrated in (D) and (E) of FIG. 6, (D) and (E) of FIG. 7, and (D) and (E) of FIG. 8 may be performed.

With this configuration, since the performance related to the character D1 can be performed every time the maintenance is executed, the user who views the character D1 can enhance the sense of intimacy to the character D1 and can enhance the attachment to the vehicle C1. Since the user can view the change of the character D1 every time the maintenance is executed, it is possible to increase the initiative to actively manage the vehicle C1 and to increase the execution frequency of the maintenance on the vehicle C1.

In the display control method according to the present embodiment, in the control processing (steps S702, S703, and S705), different performances are performed based on places where the maintenance is executed.

With this configuration, for example, it is possible to increase an opportunity to execute the maintenance at a specific facility by performing different performances depending on whether the place where the maintenance is executed is a specific facility.

In the display control method according to the present embodiment, in the control processing (steps S702 to S705), a performance using the character D1 changed to the deterioration mode based on the deterioration degree of the vehicle C1 is performed. For example, it is possible to perform performances as illustrated in (B) and (C) of FIG. 6, (B) and (C) of FIG. 7, and (B) and (C) of FIG. 8.

With this configuration, it is possible to further cause the character D1 to express the emotion of grief by performing the performance related to the deterioration mode according to the deterioration degree of the component of the vehicle C1 or the contamination degree of the vehicle C1. Accordingly, it is possible to enhance the sense of intimacy to the character D1 and to enhance the attachment to the vehicle C1.

In the display control method according to the present embodiment, the character D1 is a character image displayed on the display unit 201.

With this configuration, the user can visually and easily grasp the change of the character D1 displayed on the display unit 201.

The information processing device 100 (management server 300, control device corresponding to information processing device 100 that changes mode of character device D11) is an information processing device that changes a mode of the character D1, and includes a situation determination unit 104 (execution determination unit 106) that determines whether maintenance of the vehicle C1 is executed, and an output control unit 109 (example of control unit) that changes at least one of an appearance or an operation of the character D1 based on execution of the maintenance.

With this configuration, a user who views the change of the character D1 after the maintenance is executed can enhance the sense of intimacy to the character D1 and can enhance the attachment to the vehicle C1. Since the user can view the change of the character D1 every time the maintenance is executed, it is possible to increase the initiative to actively manage the vehicle C1 and to increase the execution frequency of the maintenance on the vehicle C1. Accordingly, it is possible to prevent a delay in maintenance on the vehicle C1.

Each processing procedure described in the present embodiment is an example for implementing the present embodiment, and an order of a part of each processing procedure may be changed within the scope of implementing the present embodiment, or a part of each processing procedure may be omitted or other processing procedures may be added.

It should be noted that the processing described in the present embodiment is executed based on a program for causing a computer to execute each processing procedure. Therefore, the present embodiment can be grasped as an embodiment of a program that implements a function of executing the processing and a recording medium that stores the program. For example, the program can be stored in a storage device of the information processing device by performing update processing for adding a new function to the information processing device. Accordingly, it is possible to cause the updated information processing device to execute the processing described in the present embodiment.

Although the embodiment of the present invention has been described above, the above embodiment merely exemplifies some of application examples of the present invention and does not intend to limit the technical scope of the present invention to the specific configurations of the above embodiment.

The present application claims priority based on Japanese Patent Application No. 2022-78424 filed to the Japan Patent Office on May 11, 2022, and the entire contents of this application are incorporated herein by reference.

1. A control method for an information processing device that changes a mode of a character, the control method comprising:
determination processing of determining whether maintenance of a vehicle is executed; and
control processing of changing, based on execution of the maintenance, at least one of an appearance or an operation of the character so as to be a mode related to the executed maintenance and a different mode according to a maintenance content

2. The control method according to claim 1, further comprising:
determination processing of determining a deterioration degree of the vehicle,
wherein in the control processing, at least one of the appearance or the operation of the character is changed, based on the deterioration degree, in a deterioration mode different from a change based on the execution of the maintenance.

3. The control method according to claim 2, wherein the deterioration degree of the vehicle is at least one of a deterioration degree of a component of the vehicle or a contamination degree of the appearance of the vehicle, and
wherein in the control processing, a mode in which a deterioration state of the vehicle assumed to occur based on the deterioration degree of the vehicle is reflected in the character is set as the deterioration mode.

4. The control method according to claim 2, wherein the character is a pseudo-biological character capable of expressing emotions of joy, anger, grief, and pleasure, and
wherein in the control processing, a mode in which when the deterioration degree of the vehicle deteriorates, the emotion of grief of the character increases according to the deterioration is set as the deterioration mode.

5. The control method according to claim 2, wherein in the control processing, a mode in which when the deterioration degree of the vehicle deteriorates, the character is contaminated according to the deterioration is set as the deterioration mode.

6. The control method according to claim 2, wherein in the control processing, blur processing is performed in which when the deterioration degree of the vehicle deteriorates, at least a part of the appearance of the character is blurred according to the deterioration.

7. The control method according to claim 2, wherein the character is a pseudo-biological character capable of moving, and
wherein in the control processing, a mode in which when the deterioration degree of the vehicle deteriorates, a movement speed of the character decreases or a movement amount of the character decreases according to the deterioration is set as the deterioration mode.

8. The control method according to claim 2, wherein the character is a character having a reference mode as a reference,
wherein the execution of the maintenance is execution of at least one of replacement of a component of the vehicle, replenishment of a component of the vehicle, cleaning of the vehicle, or inspection of the vehicle, and
wherein in the control processing, the character is changed from the deterioration mode to the reference mode after the execution of the maintenance.

9. The control method according to claim 1, wherein the execution of the maintenance is execution of at least one of replacement of a component of the vehicle, replenishment of a component of the vehicle, cleaning of the vehicle, or inspection of the vehicle, and
wherein in the control processing, at least one of the appearance or the operation of the character is changed when the maintenance is executed, so as to reflect, in the character, a mode related to a state of the vehicle assumed to occur based on the execution of the maintenance.

10. The control method according to claim 1, wherein in the control processing, a performance using the character after the maintenance changed based on the execution of the maintenance is performed.

11. The control method according to claim 10, wherein in the control processing, different performances are performed based on a place where the maintenance is executed.

12. The control method according to claim 2, wherein in the control processing, a performance using the character changed to the deterioration mode based on the deterioration degree of the vehicle is performed.

13. The control method according to claim 1, wherein the character is a character image to be displayed on a display unit.

14. An information processing device that changes a mode of a character, comprising:
a determination unit configured to determine whether maintenance of a vehicle is executed; and
a control unit configured to change, based on execution of the maintenance, at least one of an appearance or an operation of the character so as to be a mode related to the executed maintenance and a different mode according to a maintenance content.
